(19) United States
(12) Patent Application Publication
(10) Pub. No.: US 2016/0203557 A1
(43) Pub. Date: Jul. 14, 2016

(54) ELECTRONIC TRADING SYSTEM FOR INDEX-BASED PORTFOLIO

(71) Applicant: Dhandho Holdings Corp., Irvine, CA (US)

(72) Inventor: Mohnish PABRAI, Irvine, CA (US)

(73) Assignee: Dhandho Holdings Corp., Irvine, CA (US)

(21) Appl. No.: 14/671,237

(22) Filed: Mar. 27, 2015

Related U.S. Application Data
(60) Provisional application No. 62/103,371, filed on Jan. 14, 2015.
(60) Provisional application No. 62/137,338, filed on Mar. 24, 2015.

(51) Int. Cl. G06Q 40/06

(52) U.S. Cl. CPC G06Q 40/06

(57) ABSTRACT

An electronic trading system for an index-based portfolio is configured to receive a transmission a selection of an index, a term, and an initial investment amount; receive a listing of securities in an index; place a buy order for those securities; store a representation of the portfolio in a database; monitor whether any securities were acquired or bankrupt; determine a most undervalued security; periodically allocate proceeds from acquired or bankrupt securities as well as any dividends to the most undervalued security; and sell any acquired or bankrupt securities in the portfolio.

### CROSS-REFERENCE TO RELATED APPLICATIONS

The present application claims the benefit of U.S. Provisional Application Ser. No. 62/103,371 filed Jan. 14, 2015, which is herein fully incorporated by reference for all purposes.

The present application claims the benefit of U.S. Provisional Application Ser. No. 62/137,338 filed Mar. 24, 2015, which is herein fully incorporated by reference for all purposes.

### TECHNICAL FIELD

Generally, the present disclosure relates to electronic trading systems for index-based portfolios.

### BACKGROUND

A stock market index is a statistical measurement of value based on a set of securities, such as stocks. Such measurement is often helpful to investors or money managers for tracking performance of the set of securities or a broader financial market, whether based on a certain region (e.g., national) or an industry sector (e.g., energy).

The securities within the index may be weighted and the weighting may be periodically rebalanced. One type of index is a price-weighted index, where a first security is given more weight than a second security based on the first security having a higher price per share than the second security. Another type of index is a market-value index, where a first security is given more weight than a second security based on the first security having a higher market value than the second security. Yet another type of index is an equal-weighted index, wherein a first security is equally weighed to a second security, regardless of price or market value.

Electronic trading systems are commonly used to trade securities or derivatives over a network via an electronic trading platform, such as NASDAQ®. An electronic trading system can be configured to mirror an index, i.e., make a change to a portfolio that reflects the change made to a corresponding index. So if the S&P 500 makes a change to a listing of securities, an electronic trading system can rebalance a portfolio based on the S&P 500 using the new listing of securities. However, the electronic trading systems are not configured to create liquidity from within a stock market index based on an allocation to an undervalued portion of such index. Moreover, some electronic trading systems are not configured to create liquidity if a traded entity is either merged, acquired, liquidated, bankrupt, issues dividends, or dropped from the index.

### SUMMARY

The present disclosure attempts to address the deficiencies of the conventional systems and methods. The present disclosure can also prove useful to other technical areas. Therefore, the claims should not be construed as necessarily limited to addressing any of the above.

In one embodiment, a method comprises receiving, by a trading system server, a transmission from a manager terminal comprising a selection of an index, a term, and an initial investment amount; receiving, by the trading system server, constituent data from a first data source, wherein the constituent data is informative of a plurality of constituents of the selected index; upon receiving the constituent data from the first data source, automatically transmitting, by the trading system server, a message requesting a plurality of buy orders at an electronic marketplace platform, wherein the buy orders are for a plurality of securities that correspond to the constituents based in the received constituent data, wherein the buy orders total to the initial investment amount such that the initial investment amount is a product of a number of the constituents and a constituent investment amount; generating, by the trading system server, in a database a representation of a financial portfolio based on a plurality of confirmations from the electronic marketplace platform, wherein the confirmations confirm the buy orders, wherein the term represents a trading life of the financial portfolio, wherein the representation is associated with the term; monitoring, by the trading system server, transmissions with a second data source for allocation event data, wherein the allocation event data is informative of a proceeds amount due to the financial portfolio based on an event associated with a constituent from the constituents; on a periodic basis, automatically determining, by the trading system server, a most undervalued security in the representation of the financial portfolio that has not received an allocation during the term; upon determining the most undervalued security, automatically transmitting, by the trading system server, a message requesting a buy order at the electronic marketplace platform, wherein the buy order is for the most undervalued security in the representation of the financial portfolio based on the proceeds amount; designating, by the trading system server, a representation of the most undervalued security with a mark, wherein the mark is indicative that the most undervalued security received the allocation based on the proceeds amount during the term; automatically disassociating, by the trading system server, security data for the constituent associated with the event in the representation of the financial portfolio; and transmitting, by the trading system server, a notification to the manager terminal in real-time, wherein the notification is configured for being presented via the graphical user interface such that the user is informed of a status of the financial portfolio in real-time based on the representation of the financial portfolio.

In another embodiment, a system comprises an electronic trading platform comprising: a first data source; a second data source; a database; a manager terminal; and one or more servers configured to communicate with the manager terminal, the first data source, and the second data source over a network, the one or more servers configured to: receive a transmission from the manager terminal comprising a selection of an index, a term, and an initial investment amount; receive constituent data from a first data source, wherein the constituent data is informative of a plurality of constituents of the selected index; upon receiving the constituent data from the first data source, automatically transmit a message requesting a plurality of buy orders at an electronic marketplace platform, wherein the buy orders are for a plurality of securities that correspond to the constituents based in the received constituent data, wherein the buy orders total to the initial investment amount such that the initial investment amount is a product of a number of the constituents and a constituent investment amount; generate in the database a representation of a financial portfolio based on a plurality of confirmations from the electronic marketplace platform, wherein the confirmations confirm the buy orders, wherein the term represents a trading life of the financial portfolio, wherein the representation is associated with the term; monitor transmissions with the second data source for allocation event data, wherein the allocation event data is informative of a proceeds amount due to the financial portfolio based on an event associated with a constituent from the constituents; on a periodic basis, automatically determine a most undervalued security in the representation of the financial portfolio that has not received an allocation during the term; upon determining the most undervalued security, automatically transmit a message requesting a buy order at the electronic marketplace platform, wherein the buy order is for the most undervalued security in the representation of the financial portfolio based on the proceeds amount; designate a representation of the most undervalued security with a mark, wherein the mark is indicative that the most undervalued security received the allocation based on the proceeds amount during the term; automatically disassociate security data for the constituent associated with the event in the representation of the financial portfolio; and transmit a notification to the manager terminal in real-time, wherein the notification is configured for being presented via the graphical user interface such that the user is informed of a status of the financial portfolio in real-time based on the representation of the financial portfolio.

In yet another embodiment, a method comprises receiving, by a trading system server, a transmission from a manager terminal comprising a selection of an index, a term, and an initial investment amount; receiving, by the trading system server, constituent data from a first data source, wherein the constituent data is informative of a plurality of constituents of the selected index; upon receiving the constituent data from the first data source, automatically transmitting, by the trading system server, a message requesting a plurality of buy orders at an electronic marketplace platform, wherein the buy orders are for a plurality of securities that correspond to the constituents based in the received constituent data, wherein the buy orders total to the initial investment amount such that the initial investment amount is a product of a number of the constituents and a constituent investment amount; generating, by the trading system server, in a database a representation of a financial portfolio based on a plurality of confirmations from the electronic marketplace platform, wherein the confirmations confirm the buy orders, wherein the term represents a trading life of the financial portfolio, wherein the representation is associated with the term; receiving, by the trading system server, a transmission of dividend amount data from a second data source, wherein the dividend amount corresponds to a plurality of dividends distributed to the securities in the representation of the financial portfolio; determining, by the trading system server, a most undervalued security in the financial portfolio that has not received an allocation based on the dividend amount during the term; transmitting, by the trading system server, a message requesting a buy order to the electronic marketplace platform, wherein the second buy order is for the most undervalued security based on the dividend amount; designating, by the trading system server, a security in the representation of the financial portfolio with a mark, wherein the mark is indicative of the most undervalued security having received the allocation during the term; and transmitting, by the trading system server, a notification to the manager terminal in real-time, wherein the notification is configured for being presented via the graphical user interface such that the user is informed of a status of the financial portfolio in real-time based on the representation.

Additional features and advantages of an embodiment will be set forth in the description that follows, and in part will be apparent from the description. The objectives and other advantages of the disclosure will be realized and attained by the structure particularly pointed out in the embodiments in the written description and claims hereof as well as the appended drawings. It is to be understood that both the foregoing general description and the following detailed description are illustrative and explanatory and are intended to provide further explanation of the claimed invention.

### BRIEF DESCRIPTION OF THE DRAWINGS

The accompanying drawings illustrate example embodiments of the present disclosure. Such drawings are not to be construed as necessarily limiting the disclosure. Like numbers and/or similar numbering scheme can refer to like and/or similar elements throughout.

FIG. 1 shows a schematic view of a network diagram according to an embodiment of the present disclosure.

FIG. 2 shows a schematic view of a logic for calculating and presenting financial information according to an embodiment of the present disclosure.

FIG. 3 shows a flowchart of a method for monitoring for corporate event information according to an embodiment of the present disclosure.

FIG. 4 shows a flowchart of a method for allocation based on a financial portfolio constituent acquisition according to an embodiment of the present disclosure.

FIG. 5 shows a flowchart of a method for representing a financial portfolio based on a constituent bankruptcy according to an embodiment of the present disclosure.

FIG. 6 shows a flowchart of a method for a dividend reallocation according to an embodiment of the present disclosure.

FIGS. 7A-7L show a table of a method for presenting financial information according to an exemplary embodiment.

### DETAILED DESCRIPTION

The present disclosure is now described more fully with reference to the accompanying drawings, in which various embodiments are shown. However, note that variations are possible and the present disclosure should not be construed as necessarily being limited to the embodiments disclosed herein. Rather, such embodiments are provided so that the present disclosure is thorough and complete, and fully conveys the concepts of the present disclosure to those skilled in the relevant art.

In an embodiment, a trading system includes a manager terminal and a trading system server. The manager terminal includes a display that presents a graphical user interface (GUI) configured to receive an input from a user, such as a financial services professional, e.g., a trader, a money manager, or an investor. The input includes a selection of an index, such as S&P 500, a term, such as 10 years, and an initial investment amount, such as $500,000. As a result, the initial constituents of the portfolio would resemble the selected index, though the resemblance to the selected index will vary as the term of the portfolio progresses. The trading system server is configured to communicate with the manager terminal, such as for status reporting or trade confirmations. The trading system server is configured to automatically receive constituent (e.g., security or stock) data from a first data source. The constituent data is informative of a plurality of constituents of the index, such as a list of constituents of the index. The first data source can be a real-time market data feed server, such as a Bloomberg® platform.

The constituents can be entities, financial instruments, or entities represented by financial instruments. The financial instruments can include, but are not limited to, a note, corporate bond, municipal bond, stock, treasury stock, debenture, mutual funds, certificate of interest, certificate of deposit, derivative, commodity, currency, trust, put, call, straddle, option, investment in a partnership, investment in a limited liability corporation, fixed income security, equity or debt security, or any other type of security or investment. In some embodiments, the financial instruments comprise public equity securities.

The trading system server is configured to request a plurality of buy orders at an electronic marketplace, such as New York Stock Exchange (NYSE®), that correspond to the constituents in the index identified by the first data source. The buy orders can total to the initial investment amount, wherein the initial investment amount is a product of a number of the constituents and a constituent investment amount. For example, if the initial investment amount is $500,000 and the number of the constituents is 500 (e.g., if based on S&P 500), then the constituent investment amount for each constituent is $1,000.

The trading system server is configured to generate a representation of a financial portfolio based on a plurality of buy order confirmations from the electronic marketplace. The representation is stored in a memory of the trading system server or in a data store coupled to the trading system server. The representation is a data structure that represents the financial portfolio and includes a security name, a security price, a date of purchase, whether the security has received an additional allocation of funds, whether the security remains as a constituent of the portfolio, or other relevant financial information for each security purchased. For example, the data structure can be an array or a data record.

The term (e.g., 10 years) represents a trading life of the financial portfolio based on which the trading system server performs operations for the representation of the financial portfolio. The data representation of the financial portfolio is associated with the term, such as via an identifier. Although the exemplary embodiment recites that the term is 10 years, it is intended that any length may be used (e.g., 5 years, 7 years, 9 years, 11 years, 12 years). If a length is shorter than 10 years, the portfolio at the conclusion of the term is more likely to resemble the initial portfolio selection based on the index. Based upon the configuration, as the length exceeds 10 years, the portfolio will have a different amount of securities in the index, which can be fewer than the original amount.

The backend end server is configured to monitor a second data source for allocation event data. The second data source can be a real-time market data feed server, such as a Bloomberg® platform. The allocation event data can be informative of a proceeds amount due to the financial portfolio based on an acquisition of a constituent in the current listing of constituents. For example, if a stock for a company ABC is listed in the S&P 500 and the company is acquired, then the second data source can provide the trading system server with the allocation event data, which is informative of the proceeds amount due to the financial portfolio based on a position of the financial portfolio in the stock for the company ABC. The trading system server is configured to determine a most undervalued security in the financial portfolio that has not received an allocation based on the proceeds amount during the term. The trading system server is configured to request a buy order at the electronic marketplace based on this determination. The buy order is based on the proceeds amount due to the acquisition of the particular constituent. The trading system server is configured to mark the security record in the data store with a mark, identifier, symbol, flag, tag, or a designation in a data record or a data field. The mark is indicative of the most undervalued security having received the allocation based on the proceeds amount during the term. The constituent is disassociated with the financial portfolio based on the acquisition via the representation. For example, such disassociation can occur via deleting a representation of the constituent from the representation or designating the representation of the constituent as inactive or no longer included in a calculation for the representation of the financial portfolio. The trading system server is configured report an update to the manager terminal in real-time. The update is presented via the graphical user interface such that the user is informed of a status of the financial portfolio in real-time based on the updated security records. Note that upon a bankruptcy or a constituent de-listing from the index, as informed via the first data source or the second data source, such as in real-time, the trading system server can be configured to sell those securities, determine the most undervalued stocks in the outstanding portfolio, and then buy those stocks. The stocks can be purchased on the next business day or some other time period following the notice of bankruptcy or de-listing. The notice may be the actual bankruptcy or de-listing, or it may be a press release or announcement of that event, as received from the first data source or the second data source. For example, the trading system server can be configured to act upon receipt of information informative of an announcement of an event, such as an announcement of a delisting in 1 month or on a certain date, not necessarily only when the event happens. Also, note that in some implementations, companies that have already received an allocation once for any reason do not receive an allocation again for the term of the financial portfolio.

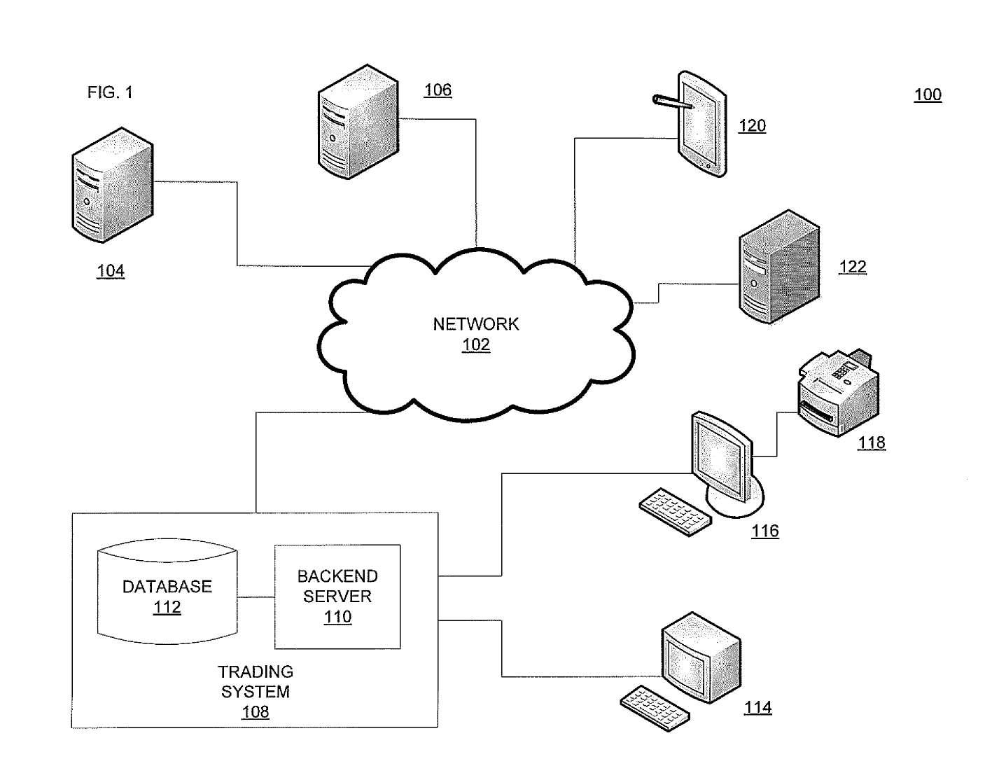

FIG. 1 shows a schematic view of a network diagram 100 according to an embodiment. The network diagram 100 shows a network 102, a market data server 104, an allocation event server 106, a trading system 108, a maintenance terminal 114, a manager terminal 116, a printer 118, a tablet computer 120, and an electronic marketplace platform 122. The trading system 108 includes a backend electronic trading system server 110 and a database 112 coupled to the backend electronic trading system server 110.

The network 102 includes a plurality of nodes, such as a collection of computers and/or other hardware interconnected via a plurality of communication channels, which allow for sharing of resources and/or information. Such interconnection can be direct and/or indirect. The network 102 can be wired and/or wireless. The network 102 can allow for communication over short and/or long distances, whether encrypted and/or unencrypted. The network 102 can operate via at least one network protocol, such as Ethernet, a Transmission Control Protocol (TCP)/Internet Protocol (IP), and the like. The network 102 can have any scale, such as a personal area network, a local area network, a home area network, a storage area network, a campus area network, a backbone network, a metropolitan area network, a wide area network, an enterprise private network, a virtual private network, a virtual network, a satellite network, a computer cloud network, an internetwork, a cellular network, and so forth. The network 102 can be and/or include an intranet and/or an extranet. The network 102 can be and/or include Internet. The network 102 can include other networks and/or allow for communication with other networks, whether sub-networks and/or distinct networks, whether identical and/or different from the network 102. The network 102 can include hardware, such as a computer, a network interface card, a repeater, a hub, a bridge, a switch, an extender, and/or a firewall, whether hardware based and/or software based. The network 102 can be operated, directly and/or indirectly, by and/or on behalf of one and/or more entities, irrespective of any relation to contents of the present disclosure.

The market data server 104 is in communication with the network 102. The market data server 104 is a specially programmed server that is configured to feed market data in real-time over the network 102 to other nodes of the network 102. The market data includes the constituent data, as described above, which is informative of the constituents of the index, such as a list of constituents of the index. For example, if the index is S&P 500, then the list of constituents includes 500 companies that define S&P 500. The constituent data can include current stock prices or any other financial information, such as acquisitions, mergers, dividends (e.g., including amount, issue date, criteria), or bankruptcy. In an embodiment, the market data server 104 is a Bloomberg® platform.

The allocation event server 106 is in communication with the network 102. The allocation event server 106 is specially programmed server that is configured to feed the allocation event data in real-time over the network 102 to other nodes of the network 102. The allocation event data is informative of the proceeds amount due to the financial portfolio based on the acquisition (or bankruptcy, delisting, or dividends) of the constituent from the set of constituents, which define the index. For example, if a stock for a company X is part of the S&P 500 and the company is acquired, then the allocation event server 106 provides the allocation event data, which is informative of the proceeds amount due to the financial portfolio based on a position of the financial portfolio in the stock for the company X. Although the exemplary embodiment recites an example where there is an acquisition of the constituent, it is intended that other events may trigger an allocation event, such as constituent dividend issue, constituent bankruptcy, constituent de-listing from the index, constituent de-listing from a stock exchange, or others. The allocation event data can include current stock prices or any other financial information, such as acquisitions, mergers, or bankruptcy. In an embodiment, the allocation event server 106 is a Thomson Reuters® platform. In an embodiment, the market data server 104 and the allocation event server 106 are one server.

The electronic marketplace platform 122 is configured to receive a buy order request or a sell order request and process such request accordingly. For example, the electronic marketplace platform is NASDAQ®. The electronic marketplace platform 122 is configured to send a buy confirmation based on the buy order, which confirms execution of the buy order and contains relevant confirming information. The electronic marketplace platform 122 is configured to send a sell confirmation based on the sell order, which confirms execution of the sell order and contains relevant confirming information. In some embodiments, the backend server 110 can be in concurrent network communication, such as data receipt or sending, with at least two of the market data server 104, the allocation event server 106, the database 112, the maintenance terminal 114, the manager terminal 116, the tablet computer 120, and the electronic marketplace platform 122. For example, the backend server 110 can receive the market data from the market data server 104, while concurrently initiating an order request on the electronic marketplace platform 122.

The trading system 108 is in communication with the network 102. The trading system 108 is communicatively coupled to the maintenance terminal 114 and the manager terminal 116 over a network, such as network 102. The manager terminal 116 is in communication with the printer 118. The backend electronic trading system server 110 (also referred to herein as a “backend server” or a “trading system server”) is specially programmed computer that is operably coupled to the database 112 for communication therewith, such as directly and/or indirectly, wired and/or wireless, selectively and/or unselectively, encrypted and/or unencrypted. Such communication can be via a common framework/API, such as HTTPS, employed via a database management system (DBMS) hosted on the trading system server 110, such as MySQL®, Oracle®, or other suitable systems. For example, the database 112 is accessed via the trading system server 110, such as via the DBMS running on the trading system server 110. Also, note that the trading system server 110 can host the database 112 locally and/or access the database 112 remotely. Alternatively, the trading system server 110 and the database 112 can be in one locale, yet distinctly embodied. Further, note that the trading system server 110 can host and/or be operably coupled to more than one database 112, such as directly and/or indirectly, selectively and/or unselectively. Also, note that the database 112 can be hosted on more than one computing entity, such as directly and/or indirectly, selectively and/or unselectively. The database 112 can be configured as a relational database, but other database configurations are possible, such as post-relational. The database 112 includes an organized collection of data, such as financial data, analytics results, trade confirmations, financial portfolio representations, or other relevant information. The data can be of any type, whether a primitive type, such as a Boolean and/or a character, a composite type, such as an array and/or a union, and/or an abstract data type, such as a list, a queue, a deck, a stack, a string, a tree, and/or a graph. The data can be organized of any structure, such as a linear structure or a tree structure, a hash structure, a graph structure, or a diagram.

The maintenance terminal 114 is a specially-programmed computer that can be configured to allow maintenance or troubleshooting of the trading system 108, such as for the trading system server 110 or the database 112. Such maintenance or troubleshooting can involve trading settings, software updates, debugging, access control, simulation, event logging, event monitoring, automation, or others. For example, a money manager can instruct an information technology (IT) technician to access the maintenance terminal 114 and interface with the trading system server 110 to update the trading settings, such as when network configurations change or index changes.

The manager terminal 116 is a specially-programmed computer that includes the display that presents the GUI, as described above. The GUI is receives the input from the user, such as a financial services professional, trader, money manager, or investor. The input includes the selection of the index, such as S&P 500, the term (e.g., 10 years), and the initial investment amount, such as $500,000. However, note that the GUI can receive other relevant financial information as well. The manager terminal 116 is configured to print reports from the interface on the printer 118, such as in color or grayscale.

The manager terminal 116 communicates the input to the trading system server 110. In response, the trading system server 110 initiates a data request and automatically retrieves the constituent data from market data server 104. As described above, the constituent data is informative of the constituents of the index, such as a list of constituents of a selected index. The trading system server 110 stores the constituent data in the database 112.

The trading system server 110 generates and transmits a request message for a plurality of buy orders at the electronic marketplace 122. The buy orders are for a plurality of securities, which correspond to the constituents based on the constituent data, which was received via the market data server 104. The buy orders total to the initial investment amount such that the initial investment amount is a product of a number of the constituents and a constituent investment amount. For example, if the initial investment amount is $500,000 and the number of the constituents is 500, such as based on S&P 500, then the constituent investment amount for each constituent is $1,000. Although the exemplary embodiment recites a particular investment amount (e.g., initial investment of $500,000 and constituent investment amount of $1,000), it is intended that any amounts may be used, whether higher or lower, such as a configuration having a constituent investment amount of $500, $10,000, $100,000, or $1,000,000.

The electronic marketplace platform 122 sends a plurality of confirmations to the trading system server 110 such that the confirmations confirm the buy orders. In response, the trading system server 110 stores the confirmations in the database 112. Also, the trading system server 110 generates the representation of the financial portfolio based on the confirmations from the electronic marketplace platform 122, as described above. The representation is stored in a memory of the trading system server 110 or coupled to the trading system server 110, such as via the database 112. The representation is a data structure that represents the financial portfolio and includes a security name, a security price, a date of security purchase, whether the security has received an additional allocation of funds, whether the security remains as a constituent of the portfolio, or other relevant financial information, such as a quantity of the security held by the portfolio. For example, the data structure can be an array or a data record. Note that the representation is associated with the term, such as via an identifier, where the term represents the trading life of the financial portfolio based on which the trading system server 110 performs operations for the data records that represent the financial portfolio holdings.

Based on generating the representation of the financial portfolio in the database 112, the backend end server 110 monitors the allocation event server 106 in real-time for the allocation event data. As described above, the allocation event data is informative of the proceeds amount due to the financial portfolio based on the acquisition (or bankruptcy, delisting, or dividends) of a constituent from the constituents. For example, if a stock for a company ABC is part of the S&P 500 and the company is acquired, then the allocation event server 106 provides the trading system server 110 with the allocation event data, which is informative of the proceeds amount due to the financial portfolio based on a position of the financial portfolio in the stock for the company ABC. Although the exemplary embodiment recites an example where there is an acquisition of the constituent, it is intended that other events may trigger an allocation event, such as constituent dividend issue, constituent bankruptcy, constituent de-listing from the index, constituent de-listing from a stock exchange, or others.

Upon receiving the allocation event data, the trading system server 110 determines a security representation in the representation, which corresponds to a most undervalued security in the financial portfolio that has not yet received an allocation based on the proceeds amount during the term, such as during the 10 years, as previously set. Such determination occurs via the trading system server 110 requesting data searching operations in the database 112. For example, such operations can include obtaining undervalue information for a set of securities, sorting the undervalue information, selecting the most undervalued information, identifying which security such information corresponds to, and then outputting a name, a quote, or an identifier for such security.

Based on determining the security representation, which corresponds to the most undervalued security in the financial portfolio that has not yet received the allocation based on the proceeds amount during the term, the trading system server 110 requests a buy order at the electronic marketplace platform 122. The buy order is for the most undervalued security based on the security representation, as found via the database 112. The buy order is based on the proceeds amount, which is based on the proceeds due to the acquisition of the constituent from the constituents.

The electronic marketplace platform 122 sends a confirmation to the trading system server 110 such that the confirmation confirms the buy order for the most undervalued security. In response, the trading system server 110 stores the confirmation in the database 112. Also, the trading system server 110 designates the security representation with a mark, such as a flag, tag, or a designation in a data record or a data field, for instance an identifier or an alphanumeric symbol). The mark is indicative of the most undervalued security having received the allocation based on the proceeds amount during the term.

Upon such designation, the trading system server 110 reports an update, such as a message, to the manager terminal 116 in real-time. Note that the constituent is disassociated with the financial portfolio based on the acquisition, as represented via the representation of the financial portfolio. For example, such disassociation can occur via deleting a representation of the constituent from the representation or designating the representation of the constituent as inactive or no longer included in a calculation for the representation of the financial portfolio. Because the financial portfolio then contains one less constituent, then such state of being is represented in the representation of the financial portfolio. The update is presented via the graphical user interface such that the user is informed of a status of the financial portfolio in real-time based on the representation. The update can be printed on the printer 118, such as for trail creation, publication, marketing, or other purposes.

When the trading system server 110 receives bankruptcy data from at least one of the market data server 104 and the allocation event server 106 automatically, in real-time, where the bankruptcy data is indicative a constituent from the constituents, as described above, filing for bankruptcy or receiving a judgment from a bankruptcy proceeding, the trading system server 110 identifies a security representation that is representative of such constituent. The trading system server 110 designates such security representation with a mark, such as a flag or a tag or a designation in a data record or a data field, for instance an identifier or an alphanumeric symbol.

Upon such designation, the trading system server 110 reports an update, such as a message, to the manager terminal 116 in real-time. Note that the constituent, which is declared bankrupt, is disassociated with the financial portfolio based on the bankruptcy data, as represented via the representation of the financial portfolio. For example, such disassociation can occur via deleting a representation of the constituent from the representation or designating the representation of the constituent as inactive or no longer included in a calculation for the representation of the financial portfolio. In addition to removing the constituent from the index, when the index constituent company files for bankruptcy or the index announces that a constituent company is being delisted or the stock exchange announces a constituent company is being delisted, as informed via the market data server 104 or the allocation event server 106, the trading system server 100 also requests a sale of all of the shares in that company, based on the representation of the financial portfolio, on the business day that follows the announcement (or other time period shortly after the announcement). The proceeds from that sale are then allocated to investment in the next most undervalued company, via the trading system server 110, based on the representation of the financial portfolio. Resultantly, since the financial portfolio contains one less constituent, then such state of being is represented in the representation of the financial portfolio. The update is presented via the graphical user interface such that the user is informed of a status of the financial portfolio in real-time based on the representation. The update can be printed on the printer 118, such as for trail creation, publication, marketing, or other purposes.

When the trading system server 110 receives the allocation event data from the allocation event server 106 automatically, in real-time, where the allocation event data is informative of a dividend amount due to the financial portfolio, the trading system server 110 performs a set of steps. Note that the dividend amount is for a time period, such as a fiscal or a calendar quarter, based on a set of positions of the financial portfolio in a set of securities during that time period. For example, the dividend amount can be $10,000 for a calendar quarter resulting from ownership of the set of securities during that calendar quarter. Further, note that such time period is at most equal to the term, as input via the GUI into the manager terminal 116. However, note that such methodology is only one way of dividend reallocation. Another way of dividend reallocation entails programming the trading system server 110 to identify the most undervalued company at the beginning of a quarter based on the representation, to designate the most undervalued company as the dividend recipient based on the representation, and to receive dividends as the dividends are paid out throughout the quarter or some other time period, such as biannually. In another implementation, the dividend reallocation can occur in real-time, whereby the allocation to the most undervalued company occurs as soon as the dividends are issued, announced, or received.

The set of steps that the trading system server 110 performs include determining a security representation in the representation, upon receiving the allocation event data from the allocation event server 106. The security representation corresponds to a most undervalued security in the financial portfolio that has not yet received an allocation, such as based on the dividend amount, constituent acquisition, constituent bankruptcy, or other event, during the term, such as during the 10 years, as previously set. Such determination occurs via the trading system server 110 requesting data searching operations in the database 112. For example, such operations can include obtaining undervalue information for a set of securities, sorting the undervalue information, selecting the most undervalued information, identifying which security such information corresponds to, and then outputting a name, a quote, or an identifier for such security.

Based on determining the security representation, which corresponds to the most undervalued security in the financial portfolio that has not yet received the allocation, such as based on the dividend amount, constituent acquisition, constituent bankruptcy, or other event, during the term, the trading system server 110 requests a buy order at the electronic marketplace 122. The buy order is for the most undervalued security based on the security representation, as found via the database 112. The buy order is based on the dividends amount, which is based on the dividend amount due to the financial portfolio. However, note that such methodology is only one manner of allocation. Another manner of allocation entails the trading system server 112, based on the representation, allocating to a single most undervalued company throughout the quarter (or other time period) on the next business day (or in real-time) after a dividend is paid (i.e., that one undervalued company is constantly having its shares being bought based on dividends paid out).

The electronic marketplace 122 sends confirmations to the trading system server 110 such that the confirmation confirm the buy order for the most undervalued security. In response, the trading system server 110 stores the confirmation in the database 112. Also, the trading system server 110 designates the security representation with a mark, such as a flag or a tag or a designation in a data record or a data field, for instance an identifier or an alphanumeric symbol. The mark is indicative of the most undervalued security having received the allocation based on the dividend amount during the term.

Upon such designation, the trading system server 110 reports an update, such as a message, to the manager terminal 116 in real-time. Resultantly, since the financial portfolio is of different value, then such state of being is represented in the representation of the financial portfolio. The update is presented via the graphical user interface such that the user is informed of a status of the financial portfolio in real-time based on the representation. The update can be printed on the printer 118, such as for trail creation, publication, marketing, or other purposes.

The tablet computer 120 is configured to receive the update in real-time from the trading system 108 for any trading or portfolio status operations described herein. For example, the trading system server 110 reports the update to the tablet computer 120 in real-time, where because the financial portfolio contains one less constituent, the tablet computer 120 is configured to display the status of the financial portfolio as represented in the database 112. Changes to the status can be automatically and/or periodically transmitted by the trading system server 110 to the tablet computer 120. The tablet computer 120 can also wirelessly print the update from the trading system 108 to the printer 118, such as for trail creation, publication, marketing, or other purposes.

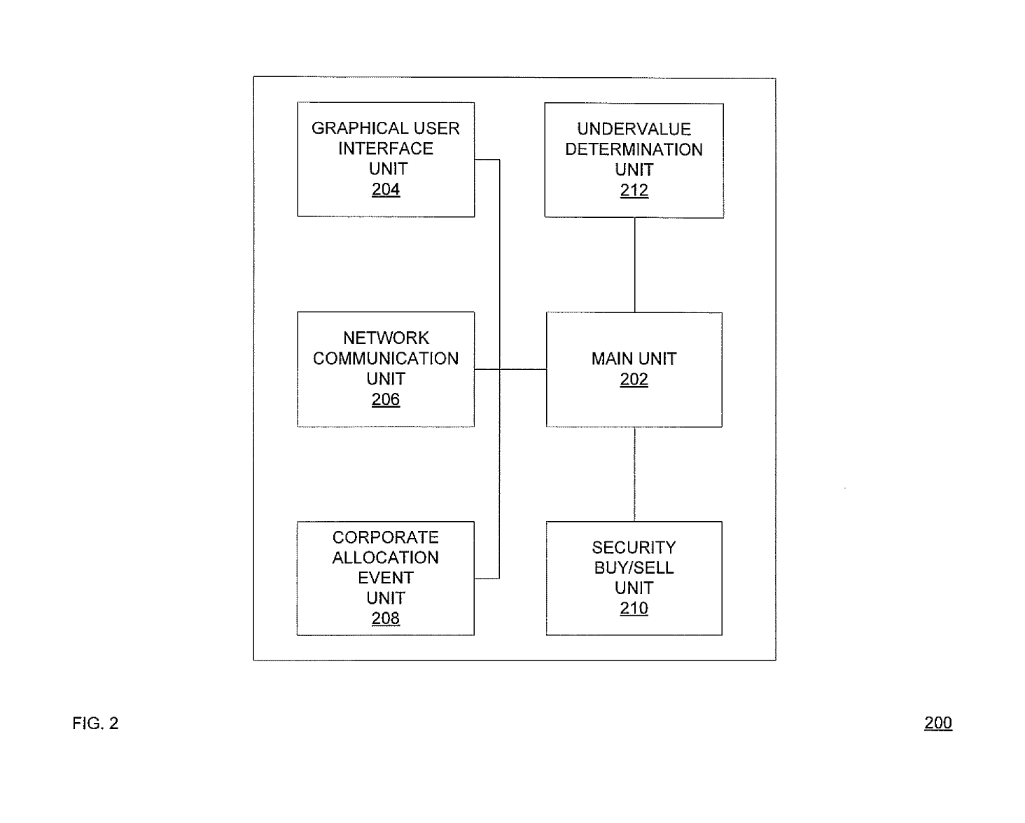

FIG. 2 shows a schematic view of a logic 200 for calculating and presenting financial information according to an embodiment of the present disclosure. Some elements of this figure are described above. Thus, same and/or similar reference characters identify same and/or like components described above and any repetitive detailed description thereof will hereinafter be omitted or simplified in order to avoid complication.

The logic 200 can be implemented via hardware, software, or any combination thereof. For example, when the logic 200 is implemented via the hardware, then such hardware can comprise one or more circuits, programmable logic controllers (PLC), gate arrays, application specific integrated circuits (ASICS), modules, chips, or any other hardware unit in any combination. Similarly, when the logic 200 is implemented via the software, then such software can comprise one or more data structures, objects, classes, functions, modules, drivers, or any other software unit/set of instructions, which can be written in any computer language, such as Java or C#, in any combination. For example, such data can be of any type, whether a primitive type, such as a Boolean and/or a character, a composite type, such as an array and/or a union, and/or an abstract data type, such as a list, a queue, a deck, a stack, a string, a tree, and/or a graph. The data can be organized of any structure, such as a linear structure, such as an array, a map, a table, a matrix, a vector, and/or a list, a tree structure, such as a tree, a pagoda, a treap, a heap, and/or a trie, a hash structure, such as a table, a list, and/or a filter, a graph structure, such as a graph, a matrix, a stack, and/or a diagram, and/or any combinations of any thereof.

The logic 200 comprises a main unit 202, a GUI unit 204, a network communication unit 206, a corporate allocation event unit 208, a security buy/sell unit 210, and an undervalue determination unit 212. Note that the logic 200 can include other units as well, such as an access control unit, an auxiliary device unit, a print unit, or others. Note that at least two of the main unit 202, the GUI unit 204, the network communication unit 206, the corporate allocation event unit 208, the security buy/sell unit 210, and the undervalue determination unit 212 can be embodied as one unit. For example, the corporate allocation event unit 208 and the undervalue determination unit 212 can be embodied as one unit. At least one of the main unit 202, the GUI unit 204, the network communication unit 206, the corporate allocation event unit 208, the security buy/sell unit 210, and the undervalue determination unit 212 can relevantly cooperate in any operable manner with at least one of the main unit 202, the GUI unit 204, the network communication unit 206, the corporate allocation event unit 208, the security buy/sell unit 210, and the undervalue determination unit 212 to implement any functionality described herein, whether statically or dynamically, whether in real-time or not, whether directly or indirectly, whether local or remote.

The main unit 202 can be implemented as a master controller that is operatively coupled to the other units (or modules). The main unit 202 is called when the logic 200 is initiated or runs throughout on demand or persistently. The main unit 202 is coupled to the GUI unit 204, the network communication unit 206, the corporate allocation event unit 208, the security buy/sell unit 210, and the undervalue determination unit 212. Such coupling can be direct or indirect, local or remote. For example, when the logic 200 is executed on a trading system server, as implemented via software, a processor of a trading system server executes a set of instructions corresponding to the unit 202. The main unit 202 can be configured to selectively call at least one of the GUI unit 204, the network communication unit 206, the corporate allocation event unit 208, the security buy/sell unit 210, and the undervalue determination unit 212 automatically, directly or indirectly, locally or remotely, on demand or persistently.

The GUI unit 204 is called by the main unit 202 to implement a GUI automatically, as described herein. The GUI can comprise any type of visual element, such as labels, tables, graphs, dropdowns, checkboxes, textboxes, buttons, or any other visual element, whether dynamic or static. For example, at least a portion of the GUI can dynamically change in real-time. In terms of relevant cooperation, for example, the GUI unit 204 can relevantly cooperate with at least the main unit 202, the corporate allocation event unit 208, the security buy/sell unit 210, and the undervalue determination unit 212, such as in real-time.

The network communication unit 206 is called by the main unit 202 to implement a network communication functionality automatically, as described herein. The network communication functionality can comprise any type of network and communication, as described herein, whether direct or indirect, local or remote. In terms of relevant cooperation, for example, the network communication unit 206 can relevantly cooperate with at least one of the corporate allocation event unit 208, the security buy/sell unit 210, and the undervalue determination unit 212, such as in real-time.

The corporate allocation event unit 208 is called by the main unit 202 to implement a corporate allocation event functionality, as described herein. For example, the corporate allocation event unit 208 is configured to generate a representation of the portfolio and perform relevant representation operations, as described herein. The corporate allocation event functionality can be performed statically or dynamically, such as in real-time. The corporate allocation unit 208 can be provided with information to implement the corporate event functionality via the main unit 202, which, for example, can relevantly cooperate with at least one of the network communication unit 206, the security buy/sell unit 210, and the undervalue determination unit 212, such as in real-time.

The security buy/sell unit 210 is called by the main unit 202 to implement a security buy/sell functionality. The security can be any type of security, such as a stock, a bond, a mutual fund, an exchange traded fund (ETF), a derivative, or any other financial asset, whether equity or debt based, whether tangible or intangible. The security buy/sell unit 210 can be provided with information to implement the buy/sell functionality via the main unit 202, which, for example, can relevantly cooperate with at least one of the network communication unit 206, the corporate allocation event unit 208, and the undervalue determination unit 212, such as in real-time.

The undervalue determination unit 212 is called by the main unit 202 to implement an undervalue determination functionality. The undervalue determination can be based on at least one of a price to earnings ratio, a price to book ratio, a price to sales ratio, an enterprise value to earnings before interest and tax ratio, and a most value lost within a selected set of securities. The undervalue determination can be performed statically or dynamically, such as in real-time. The undervalue determination unit 212 can be provided with information to implement the undervalue determination functionality via the main unit 202, which, for example, can relevantly cooperate with at least one of the GUI unit 204 and the network communication unit 206, such as in real-time.

In one mode of operation, a trading system includes a manager terminal and a trading system server. The manager terminal includes a display that presents a GUI configured to receive an input from a user, such as a financial services professional, such as a trader, a money manager, or an investor. The input includes a selection of an index, such as S&P 500, a term, such as 10 years, and an initial investment amount, such as $500,000. The trading system server implements the logic 200. Via the network communication unit 206, the trading system server communicates with the manager terminal, such as for status reporting or trade confirmations. Via the network communication unit 206, the trading system server receives constituent data from a first data source automatically. The constituent data is informative of a plurality of constituents of the index, such as a list of constituents of the index. The first data source can be a real-time market data feed server, such as a Bloomberg® platform. Via the network communication unit 206 and the security buy/sell unit 210, the trading system server requests a plurality of buy orders at an electronic marketplace, such as New York Stock Exchange (NYSE®). The buy orders are for a plurality of securities, which correspond to the constituents based on the constituent data, which was received via the first data source. The buy orders total to the initial investment amount such that the initial investment amount is a product of a number of the constituents and a constituent investment amount. For example, if the initial investment amount is $500,000 and the number of the constituents is 500, such as based on S&P 500, then the constituent investment amount for each constituent is $1,000. Via the corporate allocation event unit 208, the trading system server generates a representation of a financial portfolio based on a plurality of confirmations from the electronic marketplace. The representation is stored in a memory of the trading system server or coupled to the trading system server. The representation is a data structure that represents the financial portfolio and includes a security name, a security price, a date of purchase, whether the security has received an additional allocation of funds, whether the security remains as a constituent of the portfolio, or other relevant financial information. For example, the data structure can be an array or a data record. The confirmations confirm the buy orders. The confirmations are received from the electronic marketplace based on requesting the buy orders. The term represents a trading life of the financial portfolio based on which the trading system server performs operations for the representation of the financial portfolio. The representation is associated with the term, such as via an identifier. Via the network communication unit 206 and the corporate allocation event unit 208, the backend end server monitors a second data source for allocation event data. The second data source can be a real-time market data feed server, such as a Thomson Reuters® or Bloomberg® platform. The allocation event data is informative of a proceeds amount due to the financial portfolio based on an acquisition of a constituent from the constituents. For example, if a stock for a company ABC is part of the S&P 500 and the company is acquired, then the second data source can provide the trading system server with the allocation event data, which is informative of the proceeds amount due to the financial portfolio based on a position of the financial portfolio in the stock for the company ABC. Via the corporate allocation event unit 208 and the undervalue determination unit 212, the trading system server determines a security representation in the representation, which corresponds to a most undervalued security in the financial portfolio that has not received an allocation based on the proceeds amount during the term. Via the network communication unit 206 and the security buy/sell unit 210, the trading system server requests a buy order at the electronic marketplace. The buy order is for the most undervalued security based on the security representation. The buy order is based on the proceeds amount, which is based on the proceeds due to the acquisition of the constituent from the constituents. Via the undervalue determination unit 212, the trading system server marks the security representation with a mark, such as a flag or a tag or a designation in a data record or a data field, for instance an identifier or an alphanumeric symbol. The mark is indicative of the most undervalued security having received the allocation based on the proceeds amount during the term. The constituent is disassociated with the financial portfolio based on the acquisition via the representation. For example, such disassociation can occur via deleting a representation of the constituent from the representation or designating the representation of the constituent as inactive or no longer included in a calculation for the representation of the financial portfolio. Upon disassociating the constituent, the stock associated with that constituent in the portfolio is sold and proceeds allocated to the most undervalued constituent in the portfolio. Via the GUI unit 204 and the network communication unit 206, the trading system server reports an update to the manager terminal in real-time. The update is presented via the graphical user interface such that the user is informed of a status of the financial portfolio in real-time based on the representation.

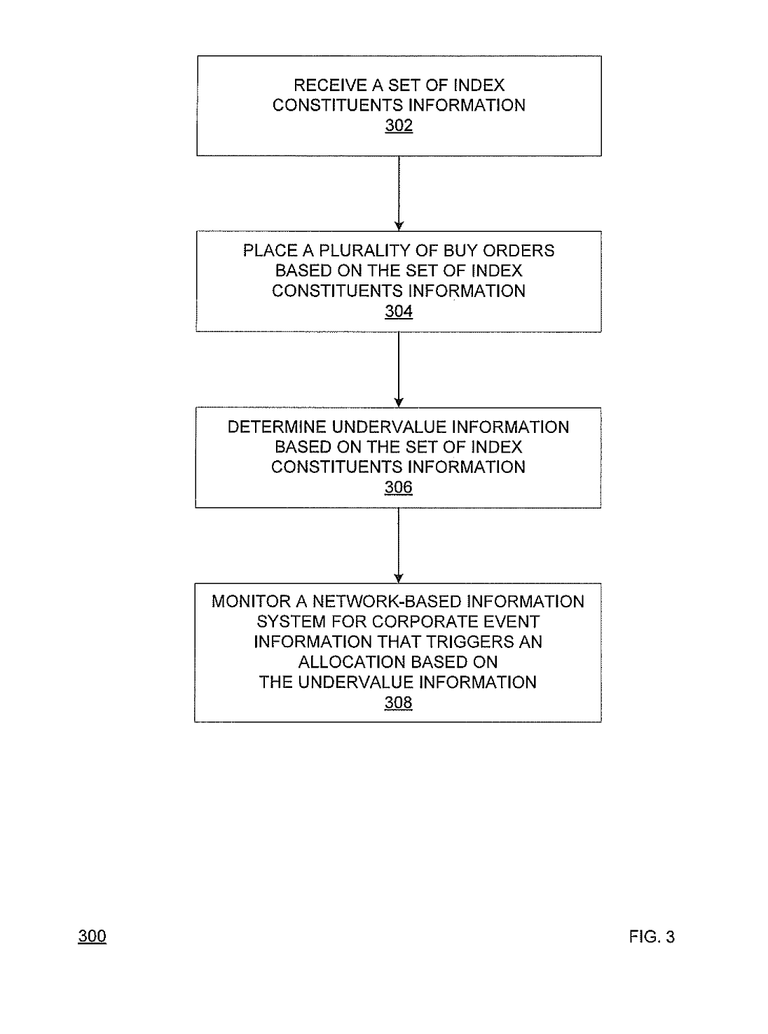

FIG. 3 shows a flowchart of a method 300 for monitoring for corporate event information according to an embodiment of the present disclosure. Some elements of this figure are described above. Thus, same and/or similar reference characters identify same and/or like components described above and any repetitive detailed description thereof will hereinafter be omitted or simplified in order to avoid complication.

The method 300 is used for monitoring corporate event information via a trading system. The method 300 includes a set of blocks 302-308, which can be performed via at least one entity, whether directly or indirectly, locally or remotely, in real-time or not. For example, the entity can comprise an investor or a money manager organized in any corporate manner. For example, the method 300 can be performed at any time or on a particular day, such as the first trading day of a given year.

In block 302, a trading system automatically receives a set of index constituents information from a market data server over a network, such as via a data feed. Such receipt is based on a GUI displayed on a manager terminal, where the GUI receives an input from a user. The input includes a selection of an index, a term, and an initial investment amount. The index constituents information is informative of a set of stock market index constituents for any type of stock market index, such as S&P 500, Wilshire 5000, or any other index, whether based on a certain region (e.g. national or international) or an industry sector (e.g., energy or technology), whether equally weighed, market value weighed, price weighed, or any other weighting. For example, the set of index constitutes information that can be informative of a set of constituents defining an index having at least 100 stocks. Upon receipt, such information is represented via a representation of a financial portfolio and a set of security representations associated with the representation. For example, the set of index constitutes information can be embodied as a list containing alphanumeric or symbolic data corresponding to the set of stock market index constituents. Such data can comprise price, shares outstanding, or other relevant financial data.

In block 304, the trading system automatically requests a placement of a plurality of buy orders at an electronic trading platform based on the set of index constituents information and the initial investment amount. For example, if the index is S&P 500, then the trading system receives the set of index constituents information for 500 stocks defining the S&P 500 and places 500 orders, with each of the orders corresponding to each of the constituents of the S&P 500 index. Accordingly, a financial portfolio is created where each of the constituents defines 0.2% of the portfolio. Note that the buy orders can be based on any type of security, such as a stock, a bond, a mutual fund, an exchange traded fund (ETF), a derivative, or any other financial asset, whether equity or debt based, whether tangible or intangible.

In some embodiments, block 302 and block 304 can be performed concurrently, in whole or in part. For example, such performance can be via concurrent computing, wherein the information indicative of the closed acquisition is received from a first data source by the trading system concurrently with the proceeds information from a second data source distinct from the first data source.

Such action is represented in the computer via a representation, which represents the financial portfolio in a memory of the trading system. The representation includes a set of security representations corresponding to the securities in the financial portfolio, such as 500 security representations in the representation of the financial portfolio, with each of the security representations representing each of the securities in the financial portfolio. Such representation can comprise alphanumeric or symbolic data corresponding to security price, shares outstanding, or other relevant data. The representation or set of security representations can be embodied via hardware, software, or any combination thereof. For example, when the representation or set of security representations is implemented via the hardware, then such hardware can comprise one or more circuits, programmable logic controllers (PLC), gate arrays, application specific integrated circuits (ASICS), modules, chips, or any other hardware unit in any combination. Similarly, when the representation or set of security representations is implemented via the software, then such software can comprise one or more data structures, objects, classes, functions, modules, drivers, or any other software unit/set of instructions, which can be written in any computer language, such as Java or C#, in any combination. For example, such data can be of any type, whether a primitive type, such as a Boolean and/or a character, a composite type, such as an array and/or a union, and/or an abstract data type, such as a list, a queue, a deck, a stack, a string, a tree, and/or a graph. The data can be organized of any structure, such as a linear structure, such as an array, a map, a table, a matrix, a vector, and/or a list, a tree structure, such as a tree, a pagoda, a treap, a heap, and/or a trie, a hash structure, such as a table, a list, and/or a filter, a graph structure, such as a graph, a matrix, a stack, and/or a diagram, and/or any combinations of any thereof. Resultantly, the representation represents the financial portfolio and includes the set of representations representing the set of securities in the financial portfolio as bought via the buy orders based on the set of index constituents information.

In block 306, the trading system automatically determines undervalue information based on the set of index constituents information. Such determination can be made via the trading system requesting data searching operations in a database. For example, such operations can include obtaining undervalue information for a set of securities, sorting the undervalue information, selecting the most undervalued information, identifying which security such information corresponds to, and then outputting a name, a quote, or an identifier for such security. Alternatively or additionally, such as for data verification, such determination can also be made via downloading the undervalue information from another data source, such as a Bloomberg® terminal, whether such information is actual undervalue information or information from which undervaluation can be determined. The undervalue information is informative of undervaluation of the set of securities contained in the financial portfolio, as represented via the representation of the financial portfolio and the set of security representations. The undervaluation can be based on at least one of a price to earnings ratio, a price to book ratio, a price to sales ratio, an enterprise value to earnings before interest and tax ratio, and a most value lost within a selected set of securities, such as the set of securities contained in the financial portfolio, as represented via the representation of the financial portfolio and the set of security representations. Note that such undervaluation can also be determined locally, based on assembling relevant information from a set of data sources, whether public or private. Upon receipt, such information is represented via the representation of the financial portfolio and the set of security representations.

In some embodiments, block 306 and block 304 can be performed concurrently, in whole or in part. For example, such performance can be via concurrent computing, wherein the undervalue information determination is performed via a first processing thread running on the trading system, while the placement of the buy orders is performed via a second processing thread distinct from the first thread on the trading system.

In block 308, the trading system automatically monitors a network-based information system, such as a corporate allocation event server, for corporate event information that triggers an allocation based on the undervalue information. Such monitoring can comprise pinging the network-based information system periodically, such as every 3 seconds or daily for an update or another time period. Alternatively or additionally, the trading system can also monitor based on a receipt of an alert involving a security included in the set of index constituents information. The network-based information system can be public or private. The corporate event information is informative of an acquisition, a bankruptcy, a dividend distribution for a security held in the financial portfolio, as represented via the representation of the financial portfolio and the set of security representations.

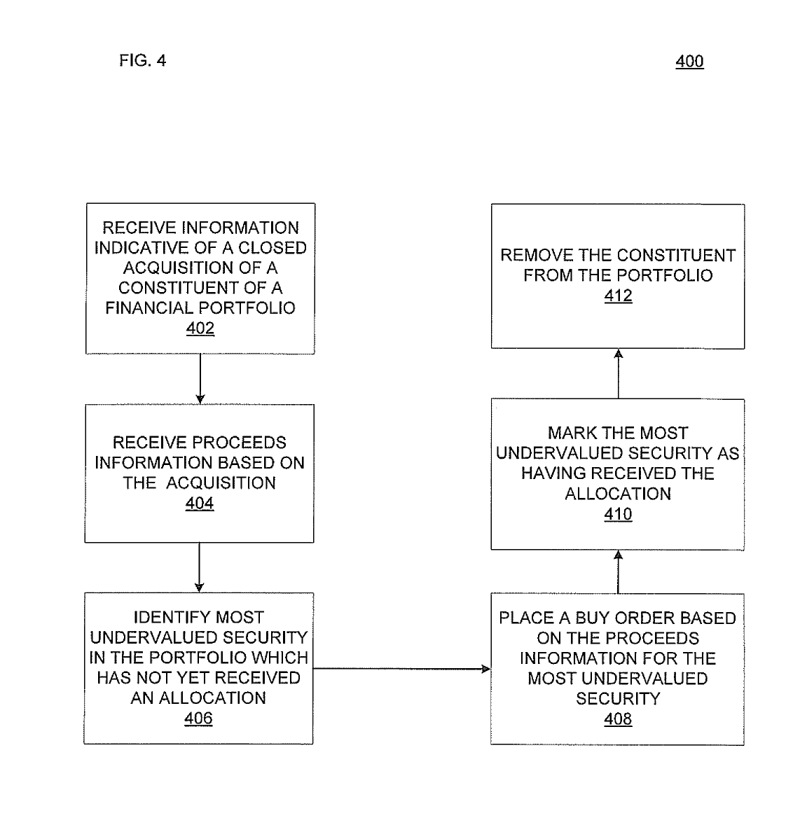

FIG. 4 shows a flowchart of a method for allocation based on a financial portfolio constituent acquisition according to an embodiment of the present disclosure. Some elements of this figure are described above. Thus, same and/or similar reference characters identify same and/or like components described above and any repetitive detailed description thereof will hereinafter be omitted or simplified in order to avoid complication.

A method 400 is used for an allocation based on a financial portfolio constituent acquisition. The method 400 includes a set of blocks 402-412, which can be performed via at least one entity, whether directly or indirectly, locally or remotely, in real-time or not. For example, the entity can comprise an investor or a money manager organized in any corporate manner.

In block 402, a trading system automatically receives information indicative of a closed acquisition of a constituent of a financial portfolio over a network from a corporate allocation event server. Such information can inform of an entity associated with a security held in the financial portfolio, as represented via the representation of the financial portfolio and the set of security representations, that the entity was acquired and the acquisition has closed. Upon receipt, such information is represented via the representation of the financial portfolio and the set of security representations.

In block 404, the trading system automatically receives proceeds information based on the acquisition over the network over from the corporate allocation event server. Such information can inform of a price for the acquisition of constituent, how much monetary proceeds are due to the financial portfolio based on a number of shares held by the financial portfolio in the constituent when the acquisition closed. When the constituent is acquired, the proceeds may be based upon receipt of a cash consideration for the security associated with that constituent, a sale of the security associated with the constituent, or a sale of a security associated with an acquirer. For example, the trading system can scan publicly available information to determine the price for the acquisition and to determine acquisition proceeds due to the financial portfolio based on the number of shares held by the financial portfolio in the constituent when the acquisition closed. Such scan can be based on the representation of the financial portfolio and the set of security representations. Upon receipt, such information is represented via the representation of the financial portfolio and the set of security representations.

In some embodiments, block 402 and block 404 can be performed concurrently, in whole or in part. For example, such performance can be via concurrent computing, wherein the information indicative of the closed acquisition is received from a first data source by the trading system concurrently with the proceeds information from a second data source distinct from the first data source.

In block 406, the trading system automatically identifies most undervalued security in the financial portfolio that has not yet received an allocation. Such identifying can be performed based on at least one of a price to earnings ratio, a price to book ratio, a price to sales ratio, an enterprise value to earnings before interest and tax ratio, and a most value lost within a selected set of securities, such as the set of securities contained in the financial portfolio, as represented via the representation of the financial portfolio and the set of security representations. Note that such undervaluation can also be determined locally, based on assembling relevant information from a set of data sources, whether public or private, and then processing based on thereon, such as via calculating.

Note that the representation is associated a time period term, as set via the GUI of a manager terminal coupled to the trading system and communicated to the trading system. Accordingly, in terms of timing for determining the allocation, the trading system considers the time period term to be a time period associated with an active life of the financial portfolio. For example, if the financial portfolio is set to exist for 10 years, based on the time period term, as represented via the representation of the financial portfolio and the set of security representations, such as measured from when the financial portfolio began actively trading until the financial portfolio actively stops trading, then the trading system determines if the allocation to the most undervalued security has occurred at least once during 10 years, as represented via the representation of the financial portfolio and the set of security representations. If the allocation occurred, as represented via the representation of the financial portfolio and the set of security representations, then the computer identifies a next most undervalued security that has not yet received the allocation during 10 years, as represented via the representation of the financial portfolio and the set of security representations. Since undervaluation information is dynamically changing, such process can be iterative, as based on undervaluation information, as represented via the representation of the financial portfolio and the set of security representations.

In some embodiments, a most undervalued security may receive an allocation (whether from a dividend, acquisition, sale of a delisted company or sale of a bankrupt company) more than once during the term (e.g., 5-year, 7-year, 10-year, 12-year period). For example, the most undervalued security can receive an allocation 1, 2, 3, 4, or 5 times during the term, or any other configuration.

In block 408, the trading system automatically requests a placement of a buy order over the network on an electronic trading platform based on the proceeds information for the most undervalued security, as represented via the representation of the financial portfolio and the set of security representations, as determined via the block 706. For example, if the proceeds information is informative of $1,000,000 dollars of proceeds due to the financial portfolio due the acquisition, then the buy order is for $1,000,000 of the most undervalued security, as represented via the representation of the financial portfolio and the set of security representations, as determined via the block 406.

In some embodiments, block 408 and 410 can be performed concurrently, in whole or in part. For example, such performance can be via concurrent computing, wherein the placement of the buy order and the marking the representation is performed concurrently by the trading system.

In block 410, the trading system automatically marks the most undervalued security as having received the allocation, as represented via the representation of the financial portfolio and the set of security representations. The marking of the security representation can be of any type, such as flag, an alphanumeric character, a symbol, or any other type of mark. Resultantly, the most undervalued security is unable to receive another allocation, at least based on an acquisition technique, during the financial portfolio lifetime, as described herein, until all other securities in the financial portfolio receive the allocation at least once and the most undervalued security again becomes most undervalued among other securities in the financial portfolio, as represented via the representation of the financial portfolio and the set of security representations. Note that upon receiving the allocation, the most undervalued security loses such classification, where the computer identifies the next most undervalued security, which has not yet received the allocation during the financial portfolio lifetime, as described herein, as represented via the representation of the financial portfolio and the set of security representations.

In block 412, the trading system automatically removes the constituent (and associated security) associated with the acquisition from the set of constituents (remove the security from the set of securities contained in the financial portfolio), as represented via the representation of the financial portfolio and the set of security representations, and the trading system sells the securities associated with the removed constituent, whereby the proceeds are allocated to the most undervalued security in the remaining set of constituents. Resultantly, the set of security representations includes one less security representation than during at least one of the block 402, the block 404, the block 406, the block 408, and the block 410.

In some embodiments, block 410 and block 412 can be performed concurrently, in whole or in part. For example, such performance can be via concurrent computing, wherein the removal of the constituent from the portfolio, in the representation, by the trading system is concurrent to the marking of block 410 by the trading system. Note that block 412 can be performed concurrently, by the trading system, with at least one of blocks 402-410, as described herein.

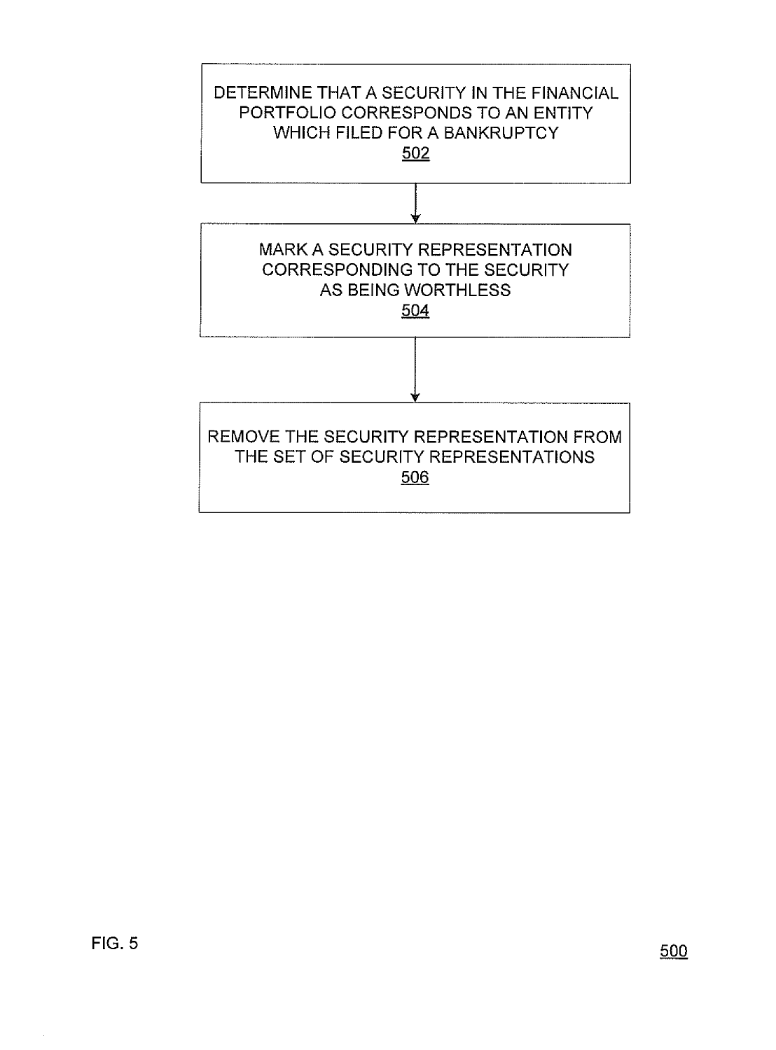

FIG. 5 shows a flowchart of a method for representing a financial portfolio based on a constituent bankruptcy according to an embodiment of the present disclosure. Some elements of this figure are described above. Thus, same and/or similar reference characters identify same and/or like components described above and any repetitive detailed description thereof will hereinafter be omitted or simplified in order to avoid complication.

A method 500 is used for representing a financial portfolio based on a constituent bankruptcy. The method 500 includes a set of blocks 502-506, which can be performed via at least one entity, whether directly or indirectly, locally or remotely, in real-time or not. For example, the entity can comprise an investor or a money manager organized in any corporate manner.

In block 502, a trading system automatically determines that a security in the financial portfolio corresponds to an entity that filed for a bankruptcy, as represented via the representation of the financial portfolio and the set of security representations. Such determination can be made via a receipt of constituent bankruptcy information over a network from a corporate allocation event server. The bankruptcy can be of any type, such as Chapter 7, Chapter 11, Chapter 13, or any other type of entity reorganization or financial declaration.

In block 504, the trading system automatically marks a security representation corresponding to the security as being associated with a constituent filing for bankruptcy or receiving a judgment from a bankruptcy proceeding, or a constituent de-listed from the index or stock exchange. The security representation can be marked worthless via an alphanumeric character, a string, or any other symbolic information. For example, the security representation can include “zero” alphanumeric string or 0 value in a relevant portion of the security representation.

In some embodiments, block 502 and block 504 can be performed concurrently, in whole or in part. For example, such performance can be via concurrent computing, wherein the bankruptcy determination occurs via a first data feed from a first data source to the trading system, while the trading system concurrently marks the security representation as bankrupt

In block 506, the trading system automatically removes the security representation from the set of security representations. Such removal is based on the trading system recognizing the security representation representing the security in the financial portfolio as being worthless, such as via the marking. The trading system also automatically sells the security and allocates the proceeds to the most undervalued security remaining in the portfolio.

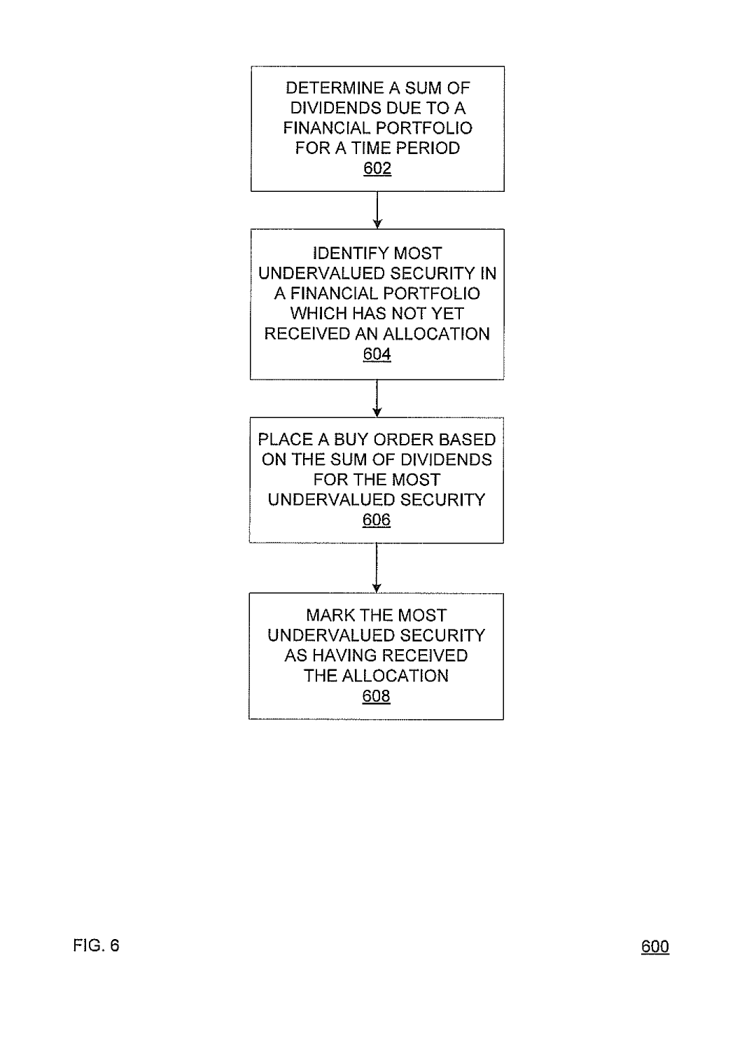

FIG. 6 shows a flowchart of a method for a dividend reallocation according to an embodiment of the present disclosure. Some elements of this figure are described above. Thus, same and/or similar reference characters identify same and/or like components described above and any repetitive detailed description thereof will hereinafter be omitted or simplified in order to avoid complication.

A method 600 is used for a dividend reallocation. The method 600 includes a set of blocks 602-608, which can be performed via at least one entity, whether directly or indirectly, locally or remotely, in real-time or not. For example, the entity can comprise an investor or a money manager organized in any corporate manner.

In block 602, a trading system automatically determines a dividend due to a financial portfolio for a time period over a network from a corporate allocation event server. The dividend is determined via information represented via the representation of the financial portfolio and the set of security representations, as prepopulated, such as periodically, for instance, daily. The time period can be a quarter, whether based on a fiscal or calendar year. However, note that other time periods are possible, such as less than 3 times a year or more than 3 times a year or more than 1 year. Note that the representation is associated a time period term, as set via the GUI of a manager terminal coupled to the trading system and communicated to the trading system. Accordingly the time period is at most equal to the time period term. However, note that such methodology is only one way of dividend reallocation. Another way of dividend reallocation entails programming the trading system server 110 to identify the most undervalued company at the beginning of a quarter based on the representation, to designate the most undervalued company as the dividend recipient based on the representation, and to receive dividends as the dividends are paid out throughout the quarter or some other time period, such as biannually or annually. In another implementation, the dividend reallocation can occur in real-time, whereby the allocation to the most undervalued company occurs as soon as the dividends are issued, announced, or received.

In block 604, the trading system automatically identifies a most undervalued security in a financial portfolio that has not yet received an allocation, as represented via the representation of the financial portfolio and the set of security representations. Such identifying can be performed based on at least one of a price to earnings ratio, a price to book ratio, a price to sales ratio, an enterprise value to earnings before interest and tax ratio, and a most value lost within a selected set of securities, such as the set of securities contained in the financial portfolio, as represented via the representation of the financial portfolio and the set of security representations. Note that such undervaluation can also be determined locally, based on assembling relevant information from a set of data sources, whether public or private, and then processing based on thereon, such as via calculating.

Note that the representation is associated the time period term, as set via the GUI of the manager terminal coupled to the trading system and communicated to the trading system. Accordingly, in terms of timing for determining the allocation, the trading system considers a time period associated with an active life of the financial portfolio. For example, if the financial portfolio is set to exist for 10 years, based on the time period term, as represented via the representation of the financial portfolio and the set of security representations, such as measured from when the financial portfolio began actively trading until the financial portfolio actively stops trading, then the computer determines if the allocation to the most undervalued security has occurred at least once during 10 years, as represented via the representation of the financial portfolio and the set of security representations. If the allocation occurred, as represented via the representation of the financial portfolio and the set of security representations, then the computer identifies a next most undervalued security that has not yet received the allocation during 10 years, as represented via the representation of the financial portfolio and the set of security representations. Since undervaluation information is dynamically changing, such process can be iterative, as based on undervaluation information, as represented via the representation of the financial portfolio and the set of security representations

In block 606, the trading system automatically places a buy order based on the dividend for the most undervalued security, as represented via the representation of the financial portfolio and the set of security representations, as determined via the block 604. Such order is placed over the network to an electronic trading platform. For example, if the dividend information is informative of $1,000,000 dollars of proceeds due to the financial portfolio due to the dividends, then the buy order is for $1,000,000 of the most undervalued security, as represented via the representation of the financial portfolio and the set of security representations, as determined via the block 604.

In block 608, the trading system automatically marks the most undervalued security as having received the allocation, as represented via the representation of the financial portfolio and the set of security representations. The marking of the security representation can be of any type, such as flag, an alphanumeric character, a symbol, or any other type of mark. The marking is automatic. Resultantly, the most undervalued security is unable to receive another allocation, during the financial portfolio lifetime, as described herein, until all other securities in the financial portfolio receive the allocation at least once and the most undervalued security again becomes most undervalued among other securities in the financial portfolio, as represented via the representation of the financial portfolio and the set of security representations. Note that upon receiving the allocation, the most undervalued security loses such classification, where the trading system identifies the next most undervalued security, which has not yet received the allocation during the financial portfolio lifetime, as described herein, as represented via the representation of the financial portfolio and the set of security representations.

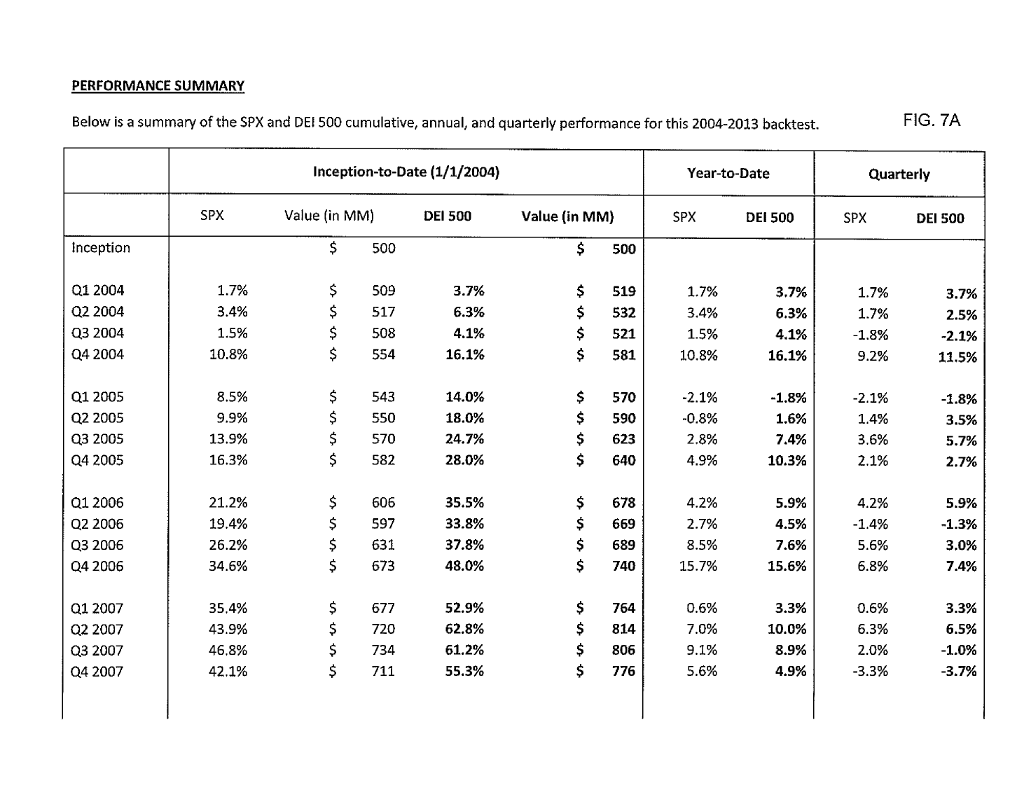

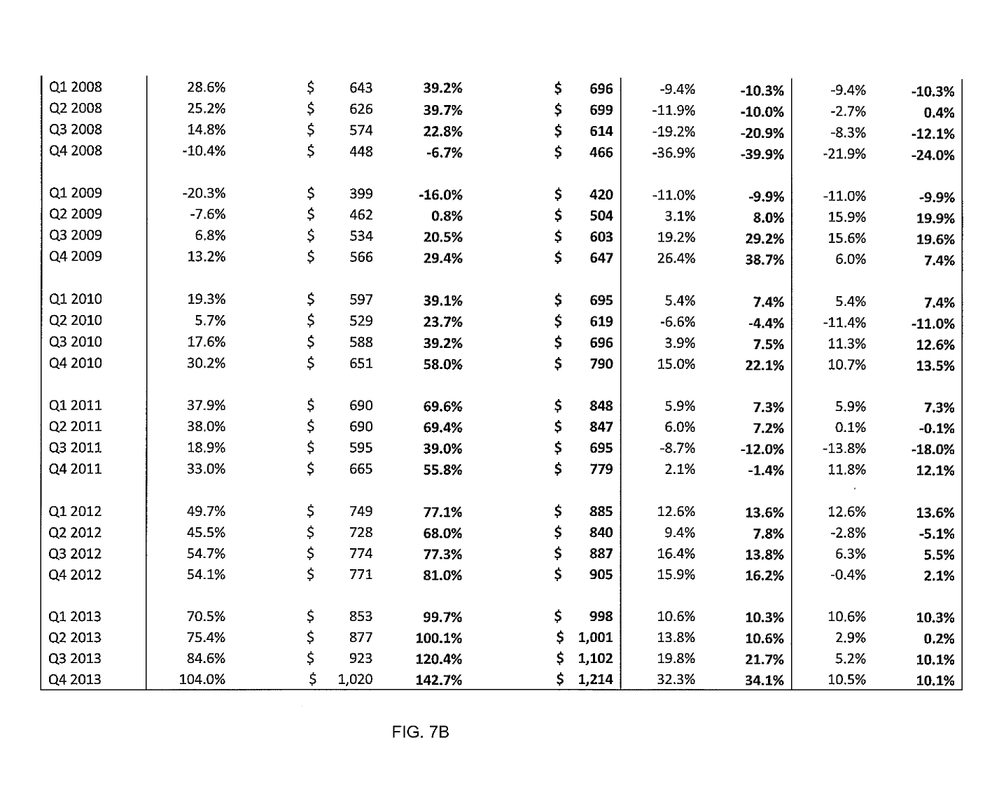

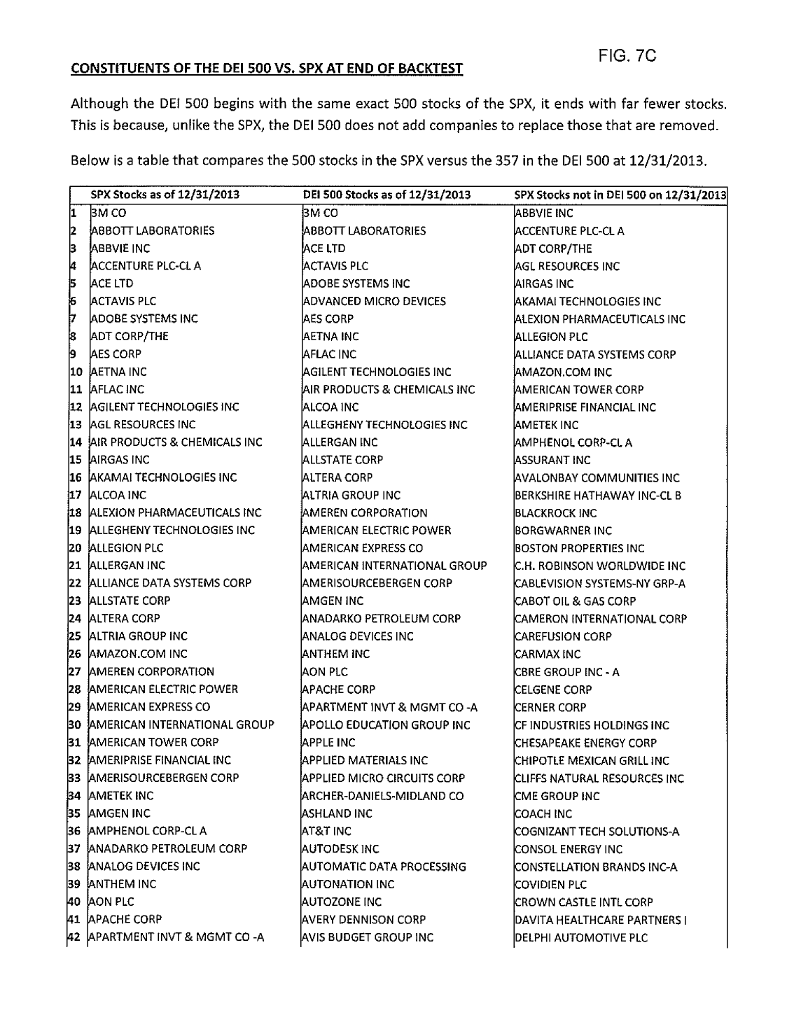

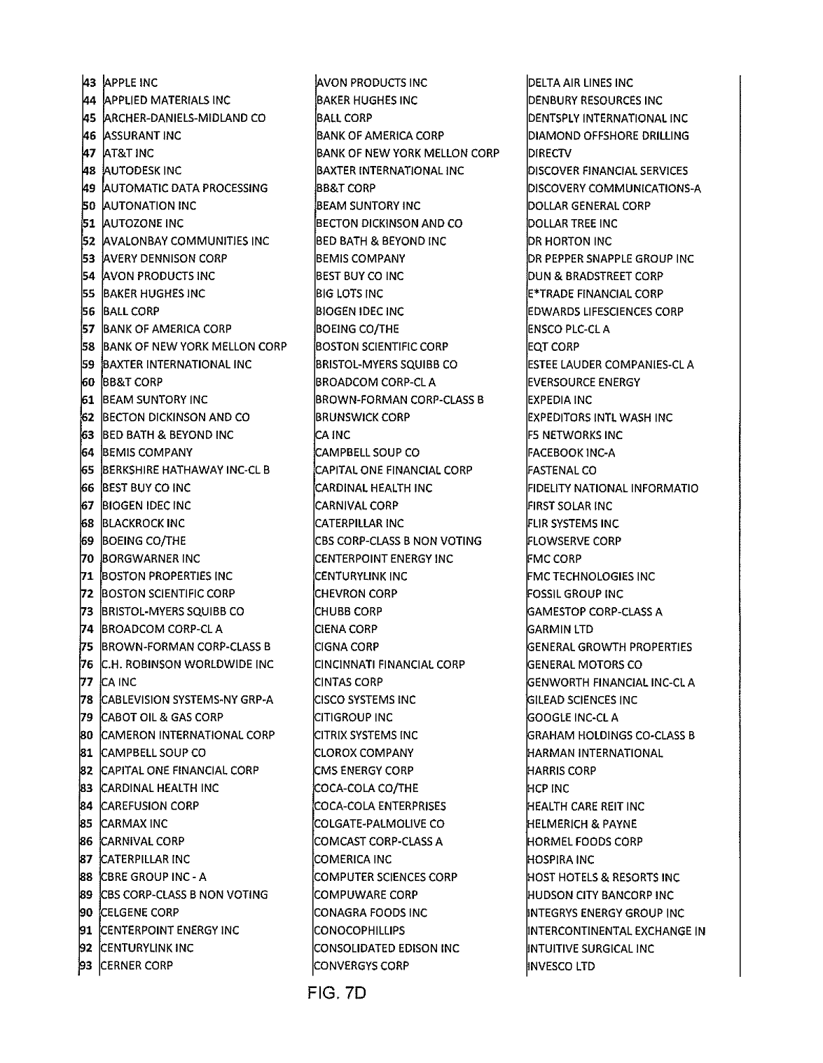

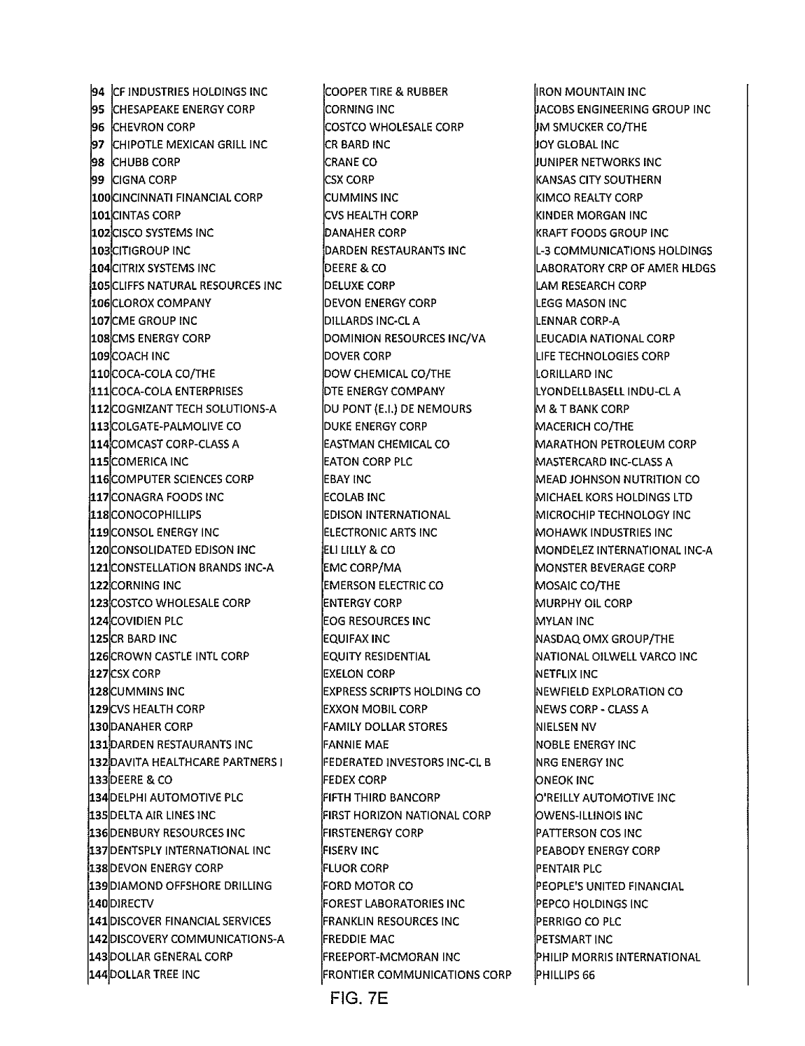

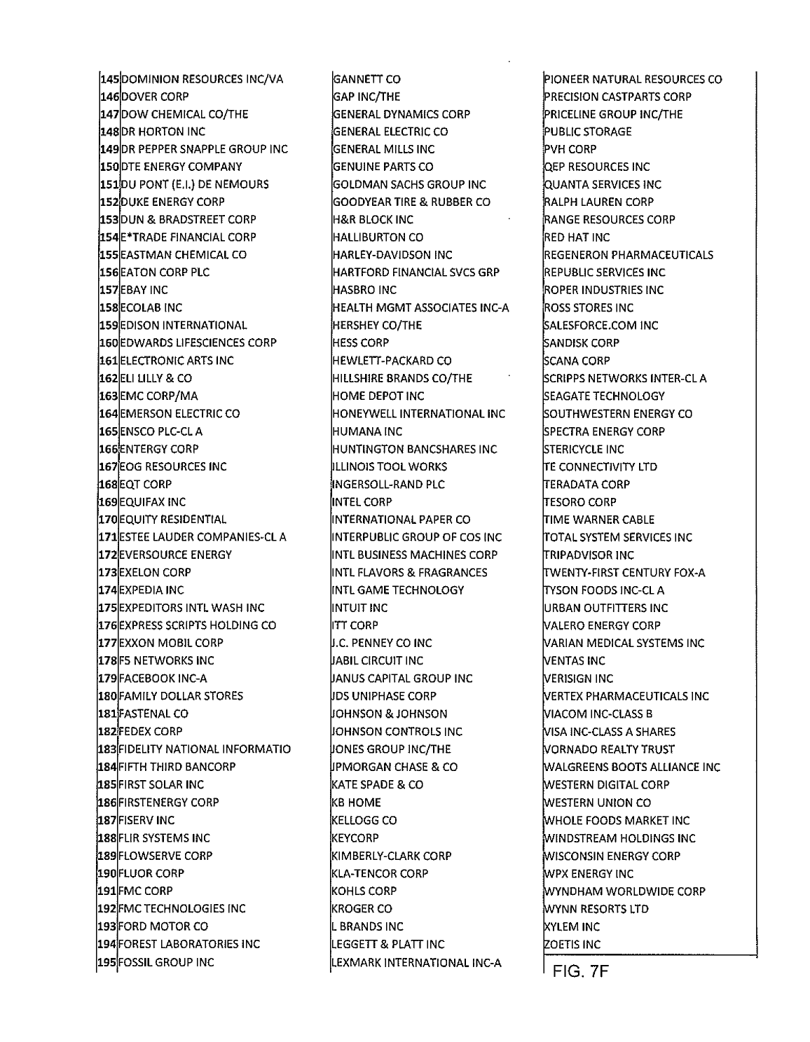

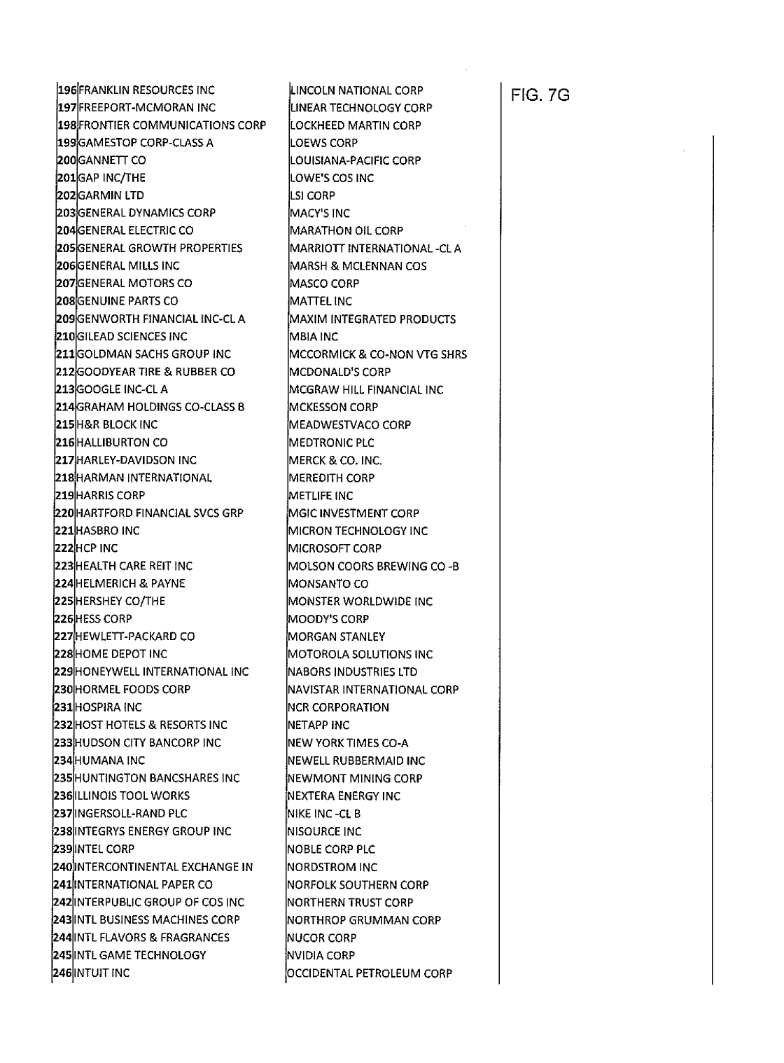

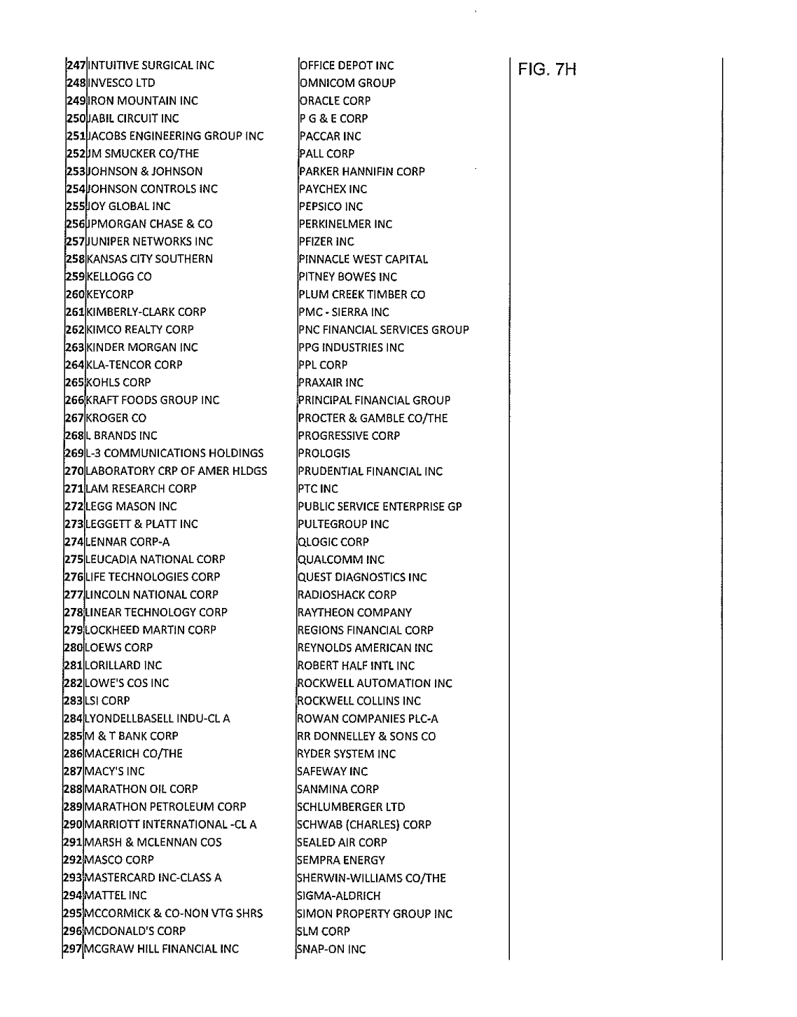

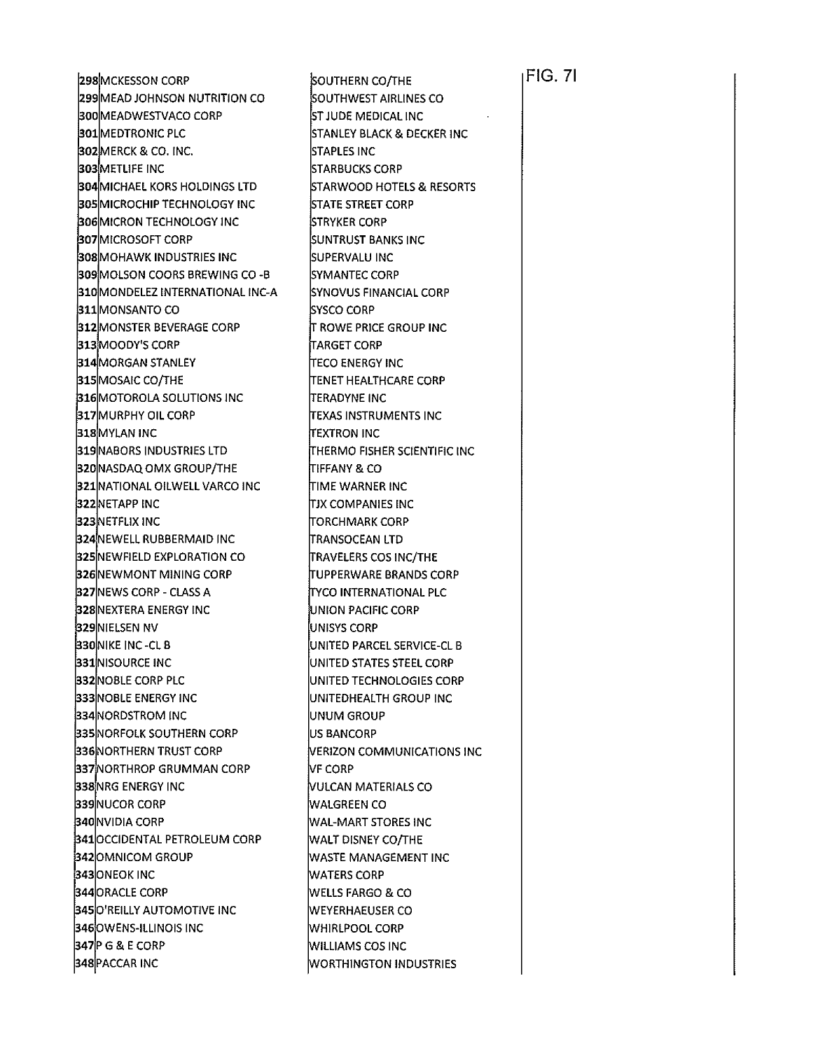

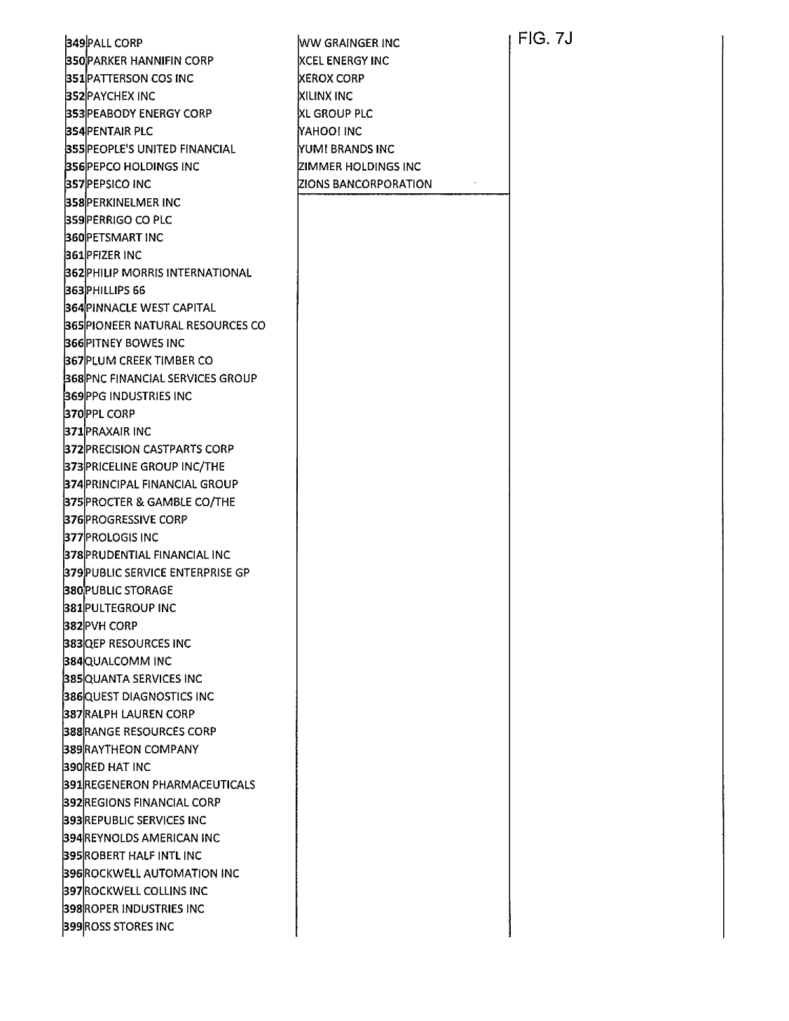

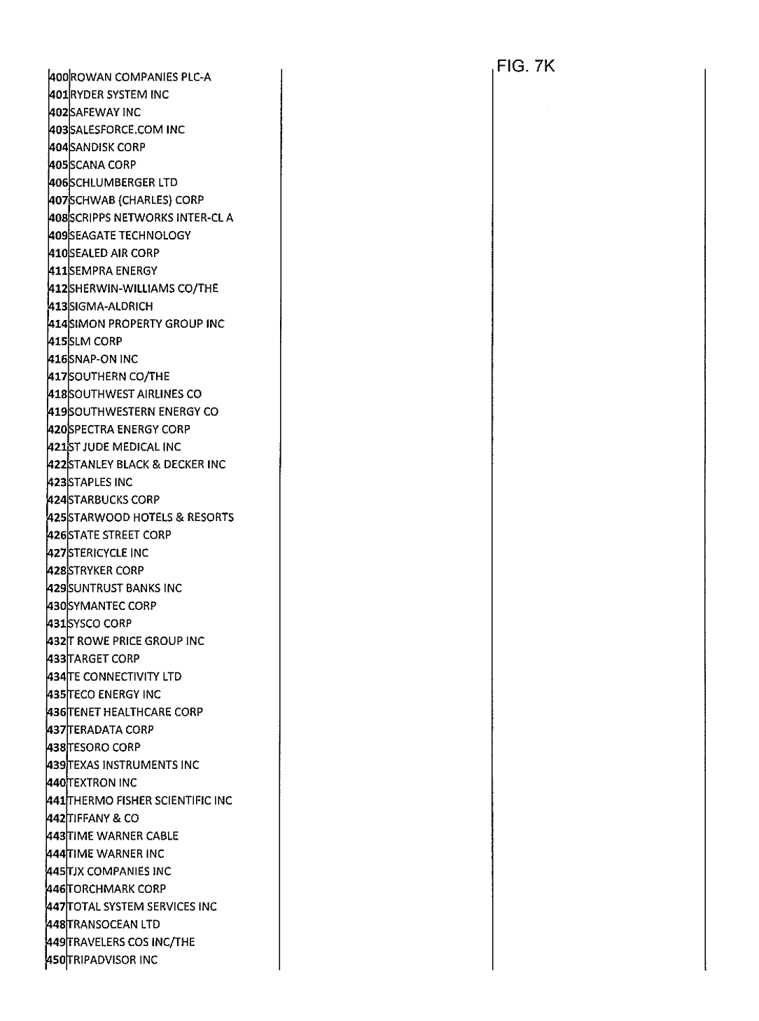

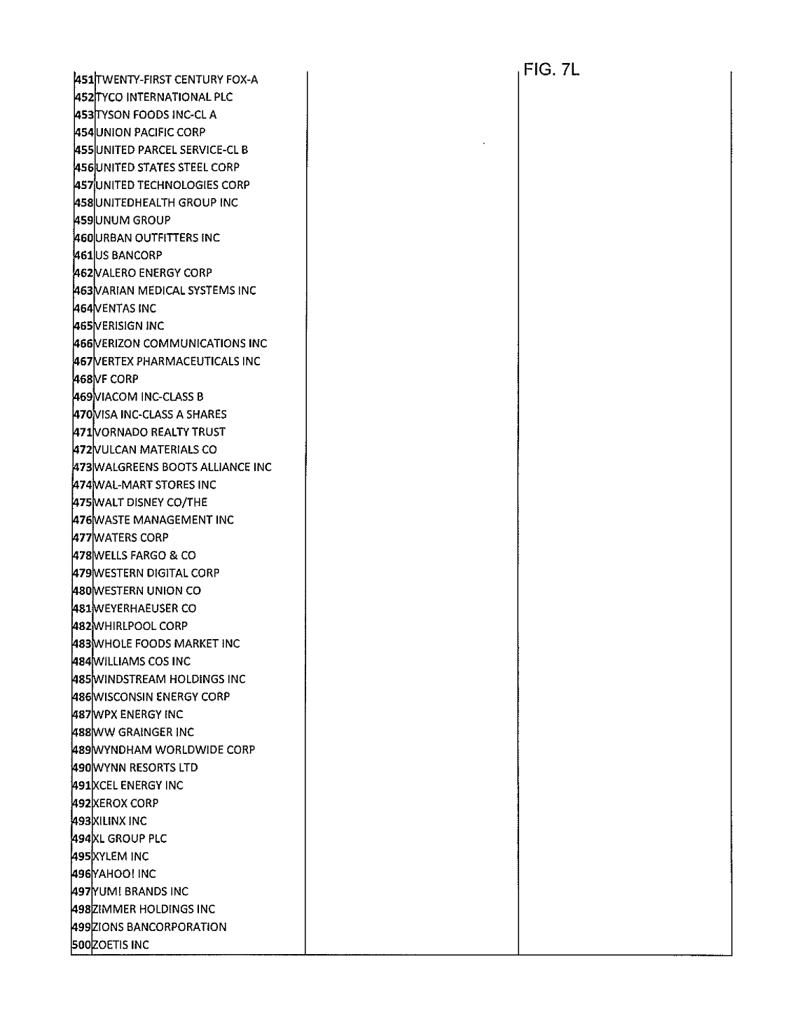

FIGS. 7A-7L shows a table of a method for calculating and presenting financial information according to an exemplary embodiment. Some elements of this figure are described above.

The table comprises data from an exemplary simulation of a Dhandho Enhanced Index (DEI) that is based on a 2004-2013 back test of the DEI S&P 500 Index (DEI 500). Presented here are the results of one decade-long back test of the DEI for the period of Jan. 1, 2004-Dec. 31, 2013. This back test is based on one variation of the DEI 500, which takes an equal weighted version of the S&P 500 Index (SPX) on the first trading day of January 2004 as its starting point. The SPX is an American stock market index that holds stocks of 500 large companies that have common stock listed on the New York Stock Exchange or NASDAQ. The SPX is a market capitalization-weighted index, which means that the weighting of each company's stock is proportionate to that company's market capitalization (calculated as the number of shares available for trading multiplied by the stock price) relative to the cumulative market capitalization of the entire index. The SPX actively keeps the weighting of each stock in sync with its relative capitalization by reinvesting dividends and rebalancing periodically (e.g., quarterly), which can assist in accounting for other corporate actions, in an attempt to maintain the integrity of the market capitalization weighting. The DEI 500 begins with the same exact 500 stocks as the SPX, but gives each constituent an equal capitalization. In the back test, $500 million was invested in each of the SPX and the DEI 500. For the investment in the DEI 500, on the first trading day of 2004, $1 million was invested on the closing price of Dec. 31, 2003 in each of the 500 stocks that make up the SPX on that date. Note that there are multiple variations of the DEI 500 that use different metrics or allocation methods than those in this back test. In addition, the DEI may be applied to any index of 100 stocks or more.

At the beginning of every quarter (or other periodic basis), the companies that remain in the index, but have not yet received an allocation of any kind to that date, are sorted by a valuation metric from most undervalued to least undervalued. This tool is called the “Valuation Tracker,” and the most undervalued company at the top of the list (i.e., the undervalued company that is next in line to receive an allocation) is referred to as a “Most Undervalued Player” (MUP). In this back test, the valuation metric used is the Trailing 12-Month Price to Earnings (P/E) ratio, which takes a stock's Price on a particular date and divides it by its cumulative 12-month Earnings Per Share as of that date. However, the Valuation Tracker can be based on a number of other methods to determine that a stock is undervalued, including, but not limited to, Price/Book, Price/Sales, Enterprise Value/EBIT, or most value lost in X weeks.

In this back test, the first MUP at the start of the quarter is designated as the dividend recipient and receives the sum of all dividends on the last trading day of the quarter. Proceeds from acquisitions and/or bankruptcies are allocated as they happen to the next MUP on the next trading day following the corporate event. This is only one variation of the DEI. In other variations, the dividend recipient receives dividends as they are paid throughout the quarter (i.e., on the next trading day following the dividend payment date).

Additionally, in this back test, the number of shares of the MUP that is bought from the acquisition or bankruptcy proceeds is based on the closing price of the MUP on the next trading day. Similarly, the number of shares of the MUP that is bought from the cumulative quarterly dividends is based on the closing price of the MUP on the last trading day of the quarter. Again, this is just one variation of the DEI In other variations, in buying shares, the DEI uses the high price on the next trading day following the event plus a 3-cent broker commission per share.

When it comes to company removals from the DEI, in this back test, only companies that file for Chapter 11 or are delisted from the New York Stock Exchange or the NASDAQ, are removed from the DEI. In other variations, the DEI also removes companies that are removed from the index that it is tracking.

In selling stocks that file for Chapter 11 bankruptcy protection or that are delisted from the stock exchange, in this back test, the DEI sells on the closing price of the next trading day following the Chapter 11 filing, or the delisting public notice. In other variations, for both events, the DEI sells on the low price of the next trading day minus a 3-cent broker commission per share.

Below is an example that shows the mechanics that are involved in the dividend, acquisition, and bankruptcy reallocation events in this DEI 500 backtest. Specifically, they are all events that take place in the third quarter of 2008 “Q3 2008,” i.e., July 1 through Sep. 30, 2008. The following is a MUP list at the beginning of Q3 2008:

| Company Name | P/E |
|---|---|
| Corning Inc. | 6.63 |
| RadioShack Corp. | 7.17 |
| BB&T Corporation | 7.35 |
| Regions Financial Corporation | 7.58 |
| Thomas & Betts Corp. | 7.71 |
| The Black & Decker Corporation | 7.98 |
| Humana Inc. | 8.09 |
| Whirlpool Corp. | 8.43 |

In Q3 2008, the list of acquisitions with their closing dates and total proceeds:

| | | | Acquisition |
|---|---|---|---|
| | Closing | Acquisition | Allocation |
| Company Name | Date | (MM) | Order |
| Countrywide Financial | Jul. 1, 2008 | $4,153 | 1 |
| Corp | | | |
| iHeart Communications, | Jul. 30, 2008 | $17,424 | 2 |
| Inc. | | | |
| HP Enterprise Services | Aug. 26, 2008 | $13,299 | 3 |
| LLC | | | |
| Safeco Corporation | Sep. 22, 2008 | $6,201 | 4 |
| Wendy's International, | Sep. 29, 2008 | $2,384 | 5 |
| LLC | | | |

In Q3 2008, there were two bankruptcies: Lehman Brothers Holdings Inc., which filed on Sep. 15, 2008, and WMI Holdings Corp, which filed on Sep. 26, 2008.

There was a reallocation of the dividends in Q3 2008. Corning Inc., the first MUP (with a P/E of 6.63), is designated as the dividend recipient that will receive the sum of all dividends paid to the DEI on the last trading day of the quarter. In this case, the total amount of dividends paid in Q3 2008 is $2,377,355. Corning Inc.'s closing price on the last trading day of the quarter is $15.64. So DEI buys 152,004 shares ($2,377,355/15.64) of Corning Inc. At the end of the quarter, the DEI has a total of 247,881 shares in Corning Inc., and the total investment in the company is valued at $3,876,856.

Prior to this dividend reallocation, the DEI's investment in Corning Inc. at the end of Q3 2008 was worth $1,499,521 based on the 95,877 shares that it owned at $15.64/share. As mentioned, after the reallocation event, the DEI's investment is worth $3,876,856.

At inception, DEI began with $1,000,000 invested in Corning Inc on Dec. 31, 2003 closing price of $10.43 per share for a total of 95,877 shares.

Before the dividend reallocation to Corning Inc. takes place, there are several acquisition reallocation events that occur. The first of these acquisitions is that of Countrywide Financial Corp by Bank of America Corp. The transaction closed on Jul. 1, 2008 and total consideration was $4.15 billion. On Jul. 1, 2008, the next MUP in line is the MUP that comes right after the dividend recipient, Corning Inc., which is RadioShack Corp (with a P/E of 7.17). On the next trading day that follows the closing of Countrywide Financial Corp's acquisition, RadioShack's closing price is $12.04 per share (on Jul. 2, 2008). As owners of 71,306 shares of Countrywide Financial Corp stock, DEI receives $511,709 in consideration, and those proceeds are used to buy 42,501 shares in RadioShack at $12.04 per share. Countrywide Financial Corp is removed from the DEI on Jul. 2, 2008.

DEI initially invested $1,000,000 in Countrywide Financial Corp on Dec. 31, 2003 closing price of $25.28 per share for a total of 39,552 shares. On Jul. 2, 2004, Countrywide was the MUP (P/E of 6.72 at the beginning of third quarter of 2004) and received a $1,134,264 investment from the proceeds of Bank One Corp's acquisition by JP Morgan for $57.8 billion. At Countrywide's price of $35.72 on the next business day following the acquisition, DEI bought 31,754 shares of the company, increasing its total ownership to 71,306 shares. At the end of the third quarter of 2004, DEI's investment in Countrywide is worth $2,808,743 when the company's closing price at the end of the quarter is $39.39.

At the end of the third quarter, DEI's investment in RadioShack at third quarter's closing price of $17.29/share increases from $563,233, prior to any adjustment, to $1,297,647 after the adjustment. DEI now owns 75,095 shares of RadioShack.

At inception, DEI began with $1,000,000 invested in RadioShack on Dec. 31, 2003 closing price of $30.68 per share for a total of 32,595 shares.

The first bankruptcy that takes place in Q3 2008 is that of Lehman Brothers Holdings, Inc., which filed on Sep. 15, 2008. On that date, the next MUP is Thomas & Betts Corp (with a P/E of 7.71). On the next business day following Lehman Brothers Holdings, Inc.'s Chapter 11 filing, DEI sells its 78,069 shares of Lehman at a closing price of $0.30 per share, and receives $23,421. With those proceeds, 556 shares of Thomas & Betts Corp are bought on the Sep. 16, 2008 closing price of $42.12 per share. Lehman Brothers Holdings, Inc. is removed from the DEI on Sep. 16, 2008.

DEI initially invested $1,000,000 in Lehman Brother Holdings, Inc. on Dec. 31, 2003 closing price of $38.61 per share for a total of 25,900 shares. On May 30, 2007, Lehman was the MUP (P/E of 10.10 at the beginning of second quarter of 2007) and received a $3,828,165 investment from the proceeds of Kinder Morgan Kansas, Inc.'s acquisition for $30.3 billion. At Lehman's price of $73.38 per share on the next business day following the acquisition, DEI bought 52,169 shares of the company, increasing its total ownership to 78,069 shares. At the end of the second quarter of 2007, DEI's investment in Lehman is worth $5,817,707 when the company's closing price at the end of the quarter is $74.52.

As a result, the investment in Thomas & Betts Corp at the end of the third quarter prior to the adjustment is valued at $1,706,859, and after purchasing the new shares is $1,728,584, at the quarter's closing price of $39.07. The DEI now owns 44,243 shares of the company at the end of Q3 2008.

At inception, DEI began with $1,000,000 invested in Thomas & Betts on Dec. 31, 2003 closing price of $22.89 per share for a total of 43,687 shares.

An exemplary electronic trading system for an index-based portfolio is specially-programmed computer system configured to receive a transmission a selection of an index, a term, and an initial investment amount; receive a listing of securities in an index; place a buy order for those securities; store a representation of the portfolio in a database; monitor whether any securities were acquired or bankrupt; determine a most undervalued security; periodically allocate proceeds from acquired or bankrupt securities as well as any dividends to the most undervalued security; and eliminate any acquired or bankrupt securities from the portfolio.

Features described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity in any manner.

The terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from the teachings of the present disclosure.

The terminology used herein is for describing particular example embodiments and is not intended to be necessarily limiting of the present disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” can be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings were turned over, then the elements described as being on the “lower” side of other elements would then be oriented on “upper” sides of the other elements. Similarly, if the device in one of the figures were turned over, elements described as “below” or “beneath” other elements would then be oriented “above” the other elements. Therefore, the example terms “below” and “lower” can encompass both an orientation of above and below.

As used herein, the term “about” and/or “substantially” refers to a +/−10% variation from the nominal value/term. Such variation is always included in any given value/term provided herein, whether or not such variation is specifically referred thereto.

If any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

In some embodiments, an apparatus or system comprise at least one processor, and memory storing instructions that, when executed by the at least one processor, cause the apparatus or system to perform one or more methodological acts as described herein. In some embodiments, the memory stores data, such as one or more structures, metadata, lines, tags, blocks, strings, or other suitable data organizations.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the disclosure. Thus, the operation and behavior of the systems and methods were described without reference to the specific software code being understood that software and control hardware can be designed to implement the systems and methods based on the description herein.

As will be appreciated by one skilled in the art, aspects of this disclosure can be embodied as a system, method or computer program product. Accordingly, aspects of the present disclosure can take the form of an entirely hardware embodiment, an entirely software embodiment (including firmware, resident software, micro-code, etc.) or as embodiments combining software and hardware aspects that can all generally be referred to herein as a “circuit,” “module” or “system.” Furthermore, aspects of the disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific example (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device. Program code embodied on a computer readable medium can be transmitted using any appropriate medium, including but not limited to wireless, wireline, optical fiber cable, radiofrequency (RF), etc., or any suitable combination of the foregoing.

Computer program code for carrying out operations for aspects of the present disclosure can be written in any combination of one or more programming language, including an object oriented programming language, such as Java, Smalltalk, C++ or the like and conventional procedural programming language, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The diagrams depicted herein are illustrative. There can be many variations to the diagram or the steps (or operations) described therein without departing from the spirit of the disclosure. For instance, the steps can be performed in a differing order or steps can be added, deleted or modified. All of these variations are considered a part of the disclosure.

The description of the present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated. It will be understood that those skilled in the art, both now and in the future, can make various improvements and enhancements which fall within the scope of the claims which follow.

In the present disclosure, where a document, an act and/or an item of knowledge is referred to and/or discussed, then such reference and/or discussion is not an admission that the document, the act and/or the item of knowledge and/or any combination thereof was at the priority date, publicly available, known to the public, part of common general knowledge and/or otherwise constitutes prior art under the applicable statutory provisions; and/or is known to be relevant to an attempt to solve any problem with which the present disclosure is concerned. Further, nothing is disclaimed.

1. A method comprising:
receiving, by a trading system server, over a network, a transmission from a manager terminal, the transmission comprising a selection of an index, a term, and an initial investment amount, the transmission is based on a manager input into a graphical user interface presented on the manager terminal;
storing, by the trading system server, the selection of the index, the term, and the initial investment amount in a trading system database;
requesting, by the trading system server, over the network, constituent data from a first data source based on accessing the selection of the index stored in the trading system database, the constituent data informing of a plurality of constituents of the index;
receiving, by the trading system server, over the network, the constituent data from the first data source;
storing, by the trading system server, the constituent data in the trading system database such that the constituent data is associated with the selection of the index;
generating, by the trading system server, a first message based on accessing the constituent data stored in the trading system database, the first message requesting a plurality of buy orders at an electronic marketplace platform, the buy orders are for a plurality of securities that correspond to the constituents based on the constituent data stored in the trading system database, the buy orders total to the initial investment amount such that the initial investment amount is a product of a number of the constituents and a constituent investment amount;
transmitting, by the trading system server, over the network, the first message to an electronic marketplace server of the electronic marketplace platform;
receiving, by the trading system server, over the network, a plurality of confirmations from the electronic marketplace server of the electronic marketplace platform, the confirmations confirming the buy orders;
generating, by the trading system server, in the trading system database, a representation of a financial portfolio based on the confirmations, the term representing a trading life of the financial portfolio, the representation is associated with the term stored in the trading server database;
monitoring, by the trading system server, in real-time, continuously, throughout the term, over the network, based on the generating of the representation of the financial portfolio, a plurality of transmissions from a second data source for allocation event data against the representation of the financial portfolio stored in the trading system database, the allocation event data is informative of a proceeds amount due to the financial portfolio based on an event associated with a constituent from the constituents, the event is during the term;
identifying, by the trading system server, in real-time, the allocation event data in at least one of the transmissions based on the monitoring;
on a periodic basis during the term, determining, by the trading system server, based on the identifying, a most undervalued security identified in the representation of the financial portfolio stored in the trading system database that has not received an allocation during the term, the determining comprising accessing the representation of the financial portfolio stored in the trading system database;
generating, by the trading system server, based on the determining, a second message requesting a buy order at the electronic marketplace platform, the buy order is based on the proceeds amount and for the most undervalued security identified in the representation of the financial portfolio stored in the trading system database;
transmitting, by the trading system server, over the network, the second message to the electronic marketplace server of the electronic marketplace platform;
designating, by the trading system server, based on the second message, a representation of the most undervalued security in the representation of the financial portfolio stored in the trading system database with a mark via accessing the trading system database, the mark is indicative that the most undervalued security received the allocation based on the proceeds amount during the term;
disassociating, by the trading system server, based on the designating, security data for the constituent associated with the event from the representation of the financial portfolio stored in the trading system database such that the representation of the financial portfolio stored in the trading system database is dynamically adjusted in the trading system database in real-time and in accordance with the mark;
generating, by the trading system server, based on the disassociating, a notification informative of a real-time status of the representation of the financial portfolio stored in the trading system database; and
transmitting, by the trading system server, over the network, the notification to the manager terminal such that the notification is able to be presented on the graphical user interface of the manager terminal and is able to allow a connection from the manager terminal to the trading system server over the network, the connection enables real-time access to the representation of the financial portfolio stored in the trading system server database when the manager terminal communicates with the trading system server while the trading system server and the manager terminal communicate with the network.

2. The method of claim 1, wherein determining the most undervalued security in the financial portfolio is based on a price to earnings ratio.

3. The method of claim 1, wherein determining the most undervalued security in the financial portfolio is based on at least one of a price to book ratio, a price to sales ratio, an enterprise value to earnings before interest and tax ratio, and a most value lost within the set of securities.

4. The method of claim 1, wherein the first data source and the second data source are one source.

5. The method of claim 1, wherein the first data source and the second data source are distinct sources.

6. The method of claim 1, wherein the mark is a first mark, wherein the update is a first update, wherein the status is a first status, and further comprising:
monitoring, by the trading system server, at least one of the first data source and the second data source for bankruptcy data, wherein the bankruptcy data is informative of a bankruptcy of a second constituent from the constituents;
designating, by the trading system server, a second security in the representation of the financial portfolio with a second mark indicative of the second constituent being declared bankrupt;
automatically disassociating, by the trading system server, security data for the bankrupt constituent in the representation of the financial portfolio;
transmitting, by the trading system server, a second notification to the manager terminal in real-time, wherein the second notification is configured for being presented via the GUI such that the user is informed of a second status of the financial portfolio in real-time based on the representation of the financial portfolio.

7. The method of claim 1, wherein the selection of the index, the term, and the initial investment amount is associated with an account identifier stored in the database coupled to the trading system server.

8. The method of claim 1, wherein the buy order is a first buy order, wherein the mark is a first mark, and further comprising:
receiving, by the trading system server, a transmission of dividend amount data from the second data source, wherein the dividend amount corresponds to a plurality of dividends distributed to the securities in the representation of the financial portfolio;
determining, by the trading system server, a second most undervalued security in the financial portfolio that has not received the allocation during the term;
transmitting, by the trading system server, a message requesting a second buy order to the electronic marketplace platform, wherein the second buy order is for the most undervalued security based on the second most undervalued security and the dividend amount;
designating, by the trading system server, a second security in the representation of the financial portfolio with a second mark, wherein the mark is indicative of the most undervalued security having received the allocation based on the dividend amount during the term; and
transmitting, by the trading system server, a notification to the manager terminal in real-time, wherein the notification is configured for being presented via the graphical user interface such that the user is informed of a status of the financial portfolio in real-time based on the representation.

9. The method of claim 1, wherein the event associated with the constituent is an acquisition of the constituent, a bankruptcy of the constituent, or a de-listing of the constituent.

10. The method of claim 9, wherein when the event is the bankruptcy of the constituent or the de-listing of the constituent, further comprising automatically generating, by the trading system server, a message requesting a sale of a security for the constituent associated with the event.

11. A system comprising:
an electronic trading platform comprising:
a first data source;
a second data source;
a database;
a manager terminal; and
one or more servers configured to communicate with the manager terminal, the first data source, and the second data source over a network, the one or more servers configured to:
receive a transmission from the manager terminal over the network, the transmission comprising a selection of an index, a term, and an initial investment amount, the transmission is based on a manager input into a graphical user interface presented on the manager terminal;
store the selection of the index, the term, and the initial investment amount in the database;
request, over the network, constituent data from the first data source based on accessing the selection of the index stored in the database, the constituent data informs of a plurality of constituents of the index;
receive, over the network, the constituent data from the first data source;
store the constituent data in the database such that the constituent data is associated with the selection of the index;
generate a first message based on accessing the constituent data stored in the database, the first message requests a plurality of buy orders at an electronic marketplace platform, the buy orders are for a plurality of securities that correspond to the constituents based on the constituent data stored in the database, the buy orders total to the initial investment amount such that the initial investment amount is a product of a number of the constituents and a constituent investment amount;
transmit, over the network, the first message to an electronic marketplace server of the electronic marketplace platform;
receive, over the network, a plurality of confirmations from the electronic marketplace server of the electronic marketplace platform, the confirmations confirm the buy orders;
generate, in the database, a representation of a financial portfolio based on the confirmations the term represents a trading life of the financial portfolio, the representation is associated with the term stored in the database;
monitor, in real-time, continuously, throughout the term, over the network, based on the generating the representation of the financial portfolio, a plurality of transmissions from the second data source for allocation event data against the representation of the financial portfolio stored in the database, the allocation event data is informative of a proceeds amount due to the financial portfolio based on an event associated with a constituent from the constituents, the event is during the term;
identify, in real-time, the allocation event data in at least one of the transmissions based on the monitoring;
on a periodic basis during the term, determine, based on the identifying, a most undervalued security identified in the representation of the financial portfolio stored in the database that has not received an allocation during the term, the determining is based on access to the representation of the financial portfolio stored in the database;
generate, based on the determining, a second message requesting a buy order at the electronic marketplace platform, the buy order is based on the proceeds amount and for the most undervalued security identified in the representation of the financial portfolio stored in the database;
transmit, over the network, the second message to the electronic marketplace server of the electronic marketplace;
designate, based on the second message, a representation of the most undervalued security in the representation of the financial portfolio stored in the database with a mark via accessing the database, the mark is indicative that the most undervalued security received the allocation based on the proceeds amount during the term;
disassociate, based on the designating, security data for the constituent associated with the event from the representation of the financial portfolio stored in the database such that the representation of the financial portfolio stored in the database is dynamically adjusted in the database in real-time and in accordance with the mark;
generate, based on the disassociating, a notification informative of a real-time status of the representation of the financial portfolio stored in the database; and
transmit, over the network, the notification to the manager terminal such that the notification is able to be presented on the graphical user interface of the manager terminal and is able to allow a connection from the manager terminal to the one or more servers over the network, the connection enables real-time access to the representation of the financial portfolio stored in the database when the manager terminal communicates with the one or more servers while the one or more servers and the manager terminal communicate with the network.

12. The system of claim 11, wherein determining the most undervalued security in the financial portfolio is based on a price to earnings ratio.

13. The system of claim 11, wherein determining the most undervalued security in the financial portfolio is based on at least one of a price to book ratio, a price to sales ratio, an enterprise value to earnings before interest and tax ratio, and a most value lost within the set of securities.

14. The system of claim 11, wherein the first data source and the second data source are one source.

15. The system of claim 11, wherein the first data source and the second data source are distinct sources.

16. The system of claim 11, wherein the mark is a first mark, wherein the update is a first update, wherein the status is a first status, wherein the one or more servers are further configured to:
monitor at least one of the first data source and the second data source for bankruptcy data, wherein the bankruptcy data is informative of a bankruptcy of a second constituent from the constituents;
designate a second security in the representation of the financial portfolio with a second mark indicative of the second constituent being declared bankrupt;
automatically disassociate security data for the bankrupt constituent in the representation of the financial portfolio; and
transmit a second notification to the manager terminal in real-time, wherein the second notification is configured for being presented via the GUI such that the user is informed of a second status of the financial portfolio in real-time based on the representation of the financial portfolio.

17. The system of claim 11, wherein the selection of the index, the term, and the initial investment amount is associated with an account identifier stored in the database coupled to the one or more servers.

18. The system of claim 11, wherein the buy order is a first buy order, wherein the mark is a first mark, and wherein the one or more servers are further configured to:
receive a transmission of a dividend amount data from the second data source, wherein the dividend amount corresponds to a plurality of dividends distributed to the securities in the representation of the financial portfolio;
determine a second most undervalued security in the financial portfolio that has not received the allocation during the term;
transmit a message requesting a second buy order to the electronic marketplace platform, wherein the second buy order is for the most undervalued security based on the second most undervalued security and the dividend amount;
designate a second security in the representation of the financial portfolio with a second mark, wherein the mark is indicative of the most undervalued security having received the allocation based on the dividend amount during the term; and
transmit a notification to the manager terminal in real-time, wherein the notification is configured for being presented via the GUI such that the user is informed of a status of the financial portfolio in real-time based on the representation.

19. The system of claim 11, wherein the event associated with the constituent is an acquisition of the constituent, a bankruptcy of the constituent, or a de-listing of the constituent.

21. The system of claim 19, wherein when the event is the bankruptcy of the constituent or the de-listing of the constituent, the one or more servers are further configured to automatically generate a message requesting a sale of a security for the constituent associated with the event.

22. A method comprising:
receiving, by a trading system server, over a network, a transmission from a manager terminal, the transmission comprising a selection of an index, a term, and an initial investment amount, the transmission is based on a manager input into a graphical user interface presented on the manager terminal, the term is from about 5 years to about 12 years;
storing, by the trading system server, the selection of the index, the term, and the initial investment amount in a trading system database;
requesting, by the trading system server, over the network, constituent data from a first data source based on accessing the selection of the index stored in the trading system database, the constituent data informing of a plurality of constituents of the index;
receiving, by the trading system server, over the network, the constituent data from the first data source;
storing, by the trading system server, the constituent data in the trading system database such that the constituent data is associated with the selection of the index;
generating, by the trading system server, a first message based on accessing the constituent data stored in the trading system database, the first message requesting a plurality of buy orders at an electronic marketplace platform, the buy orders are for a plurality of securities that correspond to the constituents based on the constituent data stored in the trading system database, the buy orders total to the initial investment amount such that the initial investment amount is a product of a number of the constituents and a constituent investment amount;
transmitting, by the trading system server, over the network, the first message to an electronic marketplace server of the electronic marketplace platform;
receiving, by the trading system server, over the network, a plurality of confirmations from the electronic marketplace server of the electronic marketplace platform, the confirmations confirming the buy orders;
generating, by the trading system server, in the trading system database, a representation of a financial portfolio based on the confirmations, the term representing a trading life of the financial portfolio, the representation is associated with the term stored in the trading system database;
receiving, by the trading system server, over the network, during the term, after the generating the representation of the financial portfolio, a real-time transmission of dividend amount data from a second data source, the dividend amount data corresponding to a plurality of dividends distributed during the term to the securities identified in the representation of the financial portfolio stored in the trading system database, wherein the dividend amount data is generated based on the representation of the financial portfolio stored in the trading system database;
determining, by the trading system server, during the term, based on the receiving of the dividend amount data, a most undervalued security identified in the representation of the financial portfolio stored in the trading system database that has not received an allocation based on the dividend amount during the term, the determining comprising accessing the representation of the financial portfolio in the trading system database;
generating, by the trading system server, based on the determining, a second message requesting a buy order at the electronic marketplace platform, the buy order is based on the dividend amount data and for the most undervalued security identified in the representation of the financial portfolio stored in the trading system database;
transmitting, by the trading system server, over the network, the second message to the electronic marketplace server of the electronic marketplace platform;
designating, by the trading system server, based on the second message, a representation of the most undervalued security in the representation of the financial portfolio stored in the trading system database with a mark via accessing the trading system database, the mark is indicative of the most undervalued security having received the allocation during the term such that the most undervalued security is unable to receive another allocation, during the term, until all other securities identified in the representation of the financial portfolio receive the allocation at least once during the term as represented in the representation of the financial portfolio and the most undervalued security again becomes most undervalued among other securities as identified in the representation of the financial portfolio stored in the trading system database;
generating, by the trading system server, based on the designating, a notification informative of a real-time status of the representation of the financial portfolio; and
transmitting, by the trading system server, over the network, the notification to the manager terminal such that the notification is able to be presented via the graphical user interface and is able to allow a connection from the manager terminal to the trading system over the network, the connection enables real-time access to the representation of the financial portfolio stored in the trading system server database when the manager terminal communicates with the trading system server while the trading system server and the manager terminal are coupled to the network.

23. The method of claim 22, wherein the most undervalued security receives each allocation during a time period in the term.

24. The method of claim 22, wherein the dividend amount corresponds to a plurality of dividends distributed to the securities in the representation of the financial portfolio over a predetermined time period.

25. The method of claim 1, wherein the term is from about 5 years to about 12 years.

26. The method of claim 25, wherein the term is greater than about 7 years.

27. The method of claim 26, wherein the term is greater than about 9 years.

28. The method of claim 27, wherein the term is greater than about 11 years.
